(19) United States
(12) Patent Application Publication
(10) Pub. No.: US 2026/0206666 A1
(43) Pub. Date: Jul. 23, 2026

(54) AGRICULTURAL MOUNTING ASSEMBLY

(71) Applicant: ToughAG, LLC, Browns Valley, MN (US)

(72) Inventor: Kelly C. Jastram, Detroit Lakes, MN (US)

(73) Assignee: ToughAG, LLC, Browns Valley, MN (US)

(21) Appl. No.: 19/644,899

(22) Filed: Apr. 10, 2026

Related U.S. Application Data
(60) Provisional application No. 63/917,367, filed on Nov. 14, 2025.

(51) Int. Cl. A01B 61/04; A01B 15/12; A01B 23/04; A01B 35/22

(52) U.S. Cl. CPC A01B 61/046; A01B 15/12; A01B 23/04; A01B 35/22

(57) ABSTRACT

A multi-component mounting assembly mounts work implements to agricultural equipment frames. The mounting assembly comprises a multi-component tower configured to retain the work implement and be mounted to the frame. The tower comprises a first and second tower sidewall. A conjoining arrangement is disposed between the first and second tower sidewalls. The conjoining arrangement interfaces with the first and second tower sidewalls to create an interlocking tower assembly. In certain examples, a strap comprises a first and second strap sidewall and a conjoining member that interfaces with the first and second strap sidewalls to create an interlocking strap assembly. The strap is configured to be secured to the tower around the frame to secure the tower to the frame.

### CROSS-REFERENCE TO RELATED APPLICATION(S)

This application claims the benefit of and priority to U.S. Application No. 63/917,367, filed on Nov. 14, 2025, titled AGRICULTURAL MOUNTING ASSEMBLY, the disclosure of which is hereby incorporated by reference in its entirety.

### BACKGROUND

Agricultural equipment can be used to prepare soil for various agricultural operations. One such type of agricultural equipment includes a plow. Plows usually utilize a plurality of ground engaging members that engage with the ground as the plow is towed. Such an operation may be used to break up soil compaction, aerate the soil, and prepare the soil for seeding.

### SUMMARY

In general terms, this disclosure is directed to an agricultural mounting assembly. In some embodiments, and by non-limiting example, the agricultural mounting assembly comprises a tower for mounting a work implement to agricultural equipment. The tower comprises a first tower sidewall that defines a first pivot pin hole and a second tower sidewall that defines a second pivot pin hole. The first and second sidewalls each define a plurality of cutouts or protrusions. The tower further comprises a conjoining plate arrangement disposed between the first and second sidewalls. The conjoining plate arrangement defines the other of the plurality of cutouts or protrusions. The cutouts are configured to receive the protrusions.

In other implementations, the agricultural mounting assembly comprises a frame engagement assembly for mounting a ground engaging work implement to a frame. The frame engagement assembly has a tower. The tower includes a first and second tower sidewall, each defining at least one cutout or protrusion. A tower conjoining plate arrangement is positioned between the first and second tower sidewalls and has the other of the at least one cutout or protrusion. The at least one cutout is configured to receive the at least one protrusion. The frame engagement assembly further includes a strap. The strap is configured to be secured to the tower conjoining plate arrangement.

In other implementations, the agricultural mounting assembly comprises a mounting assembly for mounting a ground engaging work implement to a plow frame. The mounting assembly includes a first and second mounting arm. The mounting arms have a first end to be attached to a ground engaging work implement. The mounting assembly further includes a spring bracket that is attached to a second end of the mounting arms. The spring bracket is configured to retain a spring. A tower is included to attach to the ground engaging work implement at a bottom end of the tower and to attach to a spring at a top end of the tower. The tower includes a first and second tower sidewall and a conjoining plate arrangement. The conjoining plate arrangement is at least partially welded to the first and second tower sidewall.

### BRIEF DESCRIPTION OF THE DRAWINGS

FIG. 1 is side perspective view of a plow attached to a tractor, in accordance with the principles of the present disclosure.

FIG. 2 is back perspective view of a horizontal spring orientation plow, in accordance with the principles of the present disclosure.

FIG. 3 is side perspective view of a vertical spring orientation plow, in accordance with the principles of the present disclosure.

FIG. 4 is a top perspective view of a horizontal spring orientation plow mounting assembly, in accordance with the principles of the present disclosure.

FIG. 5 is an exploded top perspective view of a spring bracket, in accordance with the principles of the present disclosure.

FIG. 6 is an assembled top perspective view of the spring bracket of FIG. 5.

FIG. 7 is an assembled front perspective view of the spring bracket of FIG. 5.

FIG. 8 is a front perspective view of a mounting arm, in accordance with the principles of the present disclosure.

FIG. 9 is an exploded top perspective view of a first implementation of a horizontal spring orientation frame-engaging assembly, in accordance with the principles of the present disclosure.

FIG. 10 is an assembled top perspective view of the frame-engaging assembly of FIG. 9.

FIG. 11 is an exploded top perspective view of a strap, in accordance with the principles of the present disclosure.

FIG. 12 is an assembled top perspective view of the strap of FIG. 11.

FIG. 13 is an assembled bottom perspective view of the strap of FIG. 11.

FIG. 14 is an exploded front perspective view of a tower, in accordance with the principles of the present disclosure.

FIG. 15 is an assembled front perspective view of the tower of FIG. 14.

FIG. 16 is an assembled back perspective view of the tower of FIG. 14.

FIG. 17 is a side view of a tower side panel, in accordance with the principles of the present disclosure.

FIG. 18 is a top view of an upper tower conjoining member, in accordance with the principles of the present disclosure.

FIG. 19 is a top view of a lower tower conjoining member, in accordance with the principles of the present disclosure.

FIG. 20 is a top view of a frame engaging tower conjoining member, in accordance with the principles of the present disclosure.

FIG. 21 is an exploded top perspective view of a second implementation of a horizontal spring orientation frame-engaging assembly, in accordance with the principles of the present disclosure.

FIG. 22 is an assembled top perspective view of the frame-engaging assembly of FIG. 21.

FIG. 23 is an exploded top perspective view of the tower of FIG. 21.

FIG. 24 is an assembled top perspective view of the tower of FIG. 21.

FIG. 25 is an assembled bottom perspective view of the tower of FIG. 21.

FIG. 26 is an exploded top perspective view of a first implementation of a vertical spring orientation frame-engaging assembly, in accordance with the principles of the present disclosure.

FIG. 27 is an assembled top perspective view of the frame-engaging assembly of FIG. 26.

FIG. 28 is an exploded top perspective view of the tower of FIG. 26.

FIG. 29 is an assembled top perspective view of the tower of FIG. 26.

FIG. 30 is an assembled bottom perspective view of the tower of FIG. 26.

FIG. 31 is an exploded top perspective view of a second implementation of a vertical spring orientation frame-engaging assembly, in accordance with the principles of the present disclosure.

FIG. 32 is an assembled top perspective view of the frame-engaging assembly of FIG. 31.

FIG. 33 is an exploded top perspective view of the tower of FIG. 31.

FIG. 34 is an assembled top perspective view of the tower of FIG. 31.

FIG. 35 is an assembled bottom perspective view of the tower of FIG. 31.

FIG. 36 is an exploded top perspective view of a third implementation of a vertical spring orientation frame-engaging assembly, in accordance with the principles of the present disclosure.

FIG. 37 is an assembled top perspective view of the frame-engaging assembly of FIG. 36.

FIG. 38 is an exploded top perspective view of the tower of FIG. 36.

FIG. 39 is an assembled top perspective view of the tower of FIG. 36.

FIG. 40 is an assembled bottom perspective view of the tower of FIG. 36.

FIG. 41 is an exploded top perspective view of a tower, in accordance with the principles of the present disclosure.

FIG. 42 is an exploded front perspective view of a pivot pin arrangement, in accordance with the principles of the present disclosure.

FIG. 43 is a perspective view of a bushing, in accordance with the principles of the present disclosure.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The various embodiments described above are provided by way of illustration only and should not be construed to limit the claims attached hereto. Those skilled in the art will readily recognize various modifications and changes that may be made without following the example embodiments and applications illustrated and described herein, and without departing from the full scope of the following claims.

It is to be appreciated that the following disclosure may be applicable to mounting different work implements to various types of agricultural equipment. For example, the agricultural equipment could include a plow, such as a field cultivator, a chisel plow, or types of fall tillage equipment.

Plows are often not used in perfect environments. For example, as a shank of the plow is dragged across the ground, the shank may contact a rock, root, or other obstruction. As a result, an opposing force may be exerted on the shank. A plow mounting assembly may be configured to attach the shank to a frame of the plow such that the shank can move upward when it is dragged over an obstruction, to reduce forces on the shank and plow and to prolong the life of the equipment. The plow frame-engaging assembly may, for example, include a tower that receives an end of the shank at a bottom of the tower. A frame-securing feature can be used to secure the tower to the plow frame. A top of the tower can receive a spring. The spring is configured to apply a downward force on the shank. This allows the shank to engage the ground with enough force to engage with the soil, but also to allow the shank to deflect upwards when the shank is pulled across an obstruction by further compressing the spring. This may prolong the life of the shank and plow by relieving the shank of large force loads.

However, soil where plows are used may contain a large quantity of obstructions. Accordingly, over its life, the shank may undergo many upward deflections, resulting in repeated compressions of the spring. This, in turn, can cause the spring to exert repeated forces on the tower assembly to which it is mounted. Such repeated forces may cause the tower assembly, or other components of the plow, to fail. Such failures can be costly, due not only for the need to buy replacement parts, but also because of the downtime of the plow while the part must be replaced. The costs of replacement and downtime can quickly add up, considering that some plows may require many shanks and tower assemblies.

The present disclosure generally relates to a mounting assembly to mount a ground engaging member to a piece of agricultural equipment. More specifically, the present disclosure generally relates to a plow mounting assembly comprised of a plurality of connecting plates for mounting a shank to a frame of a plow. By utilizing a plurality of connecting plates, the plow mounting assembly can have a longer longevity, reducing the need for costly repairs and downtime.

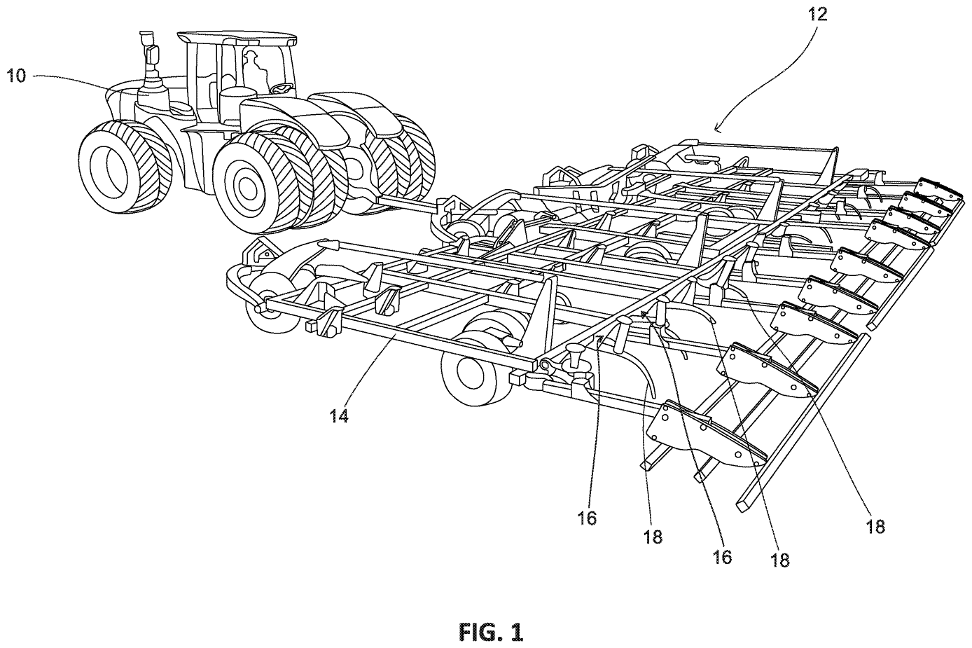

Referring to FIG. 1, a tractor 10 is shown towing a plow 12. While tractor 10 is shown, it is to be appreciated that other vehicle types may be capable of towing the plow 12. Plow 12 is shown to have a frame 14, to which a plurality of tower assemblies 16 are mounted. Further, a plurality of ground engaging members, shown as shanks 18 are mounted to the tower assemblies 16. In use, as the tractor 10 pulls the plow 12, the shanks 18 engage with the ground. Various types of shanks 18 may be used for various soil preparation purposes. For example, the shanks 18 may define different curvatures and be configured to engage with the ground with varying force in order to reach different depths.

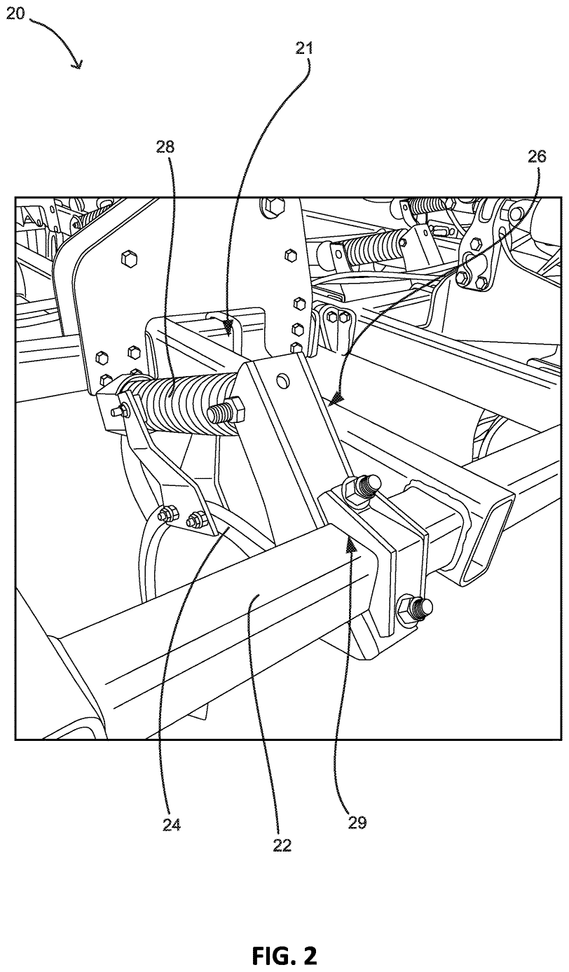

Referring to FIG. 2, a horizontal spring orientation plow 20 is shown. The plow 20 comprises a horizontal spring orientation mounting assembly 21 mounted to the plow frame 22 and to the shank 24. The horizontal spring orientation mounting assembly 21 comprises a tower 26 configured to receive a spring 28 at a top end of the tower 26, and to be secured to the frame 22 at a bottom end of the tower. The spring 28 is mounted substantially horizontal and is configured to exert a downward force on the shank 24. Further, the shank 24 is pivotally attached to the bottom end of the tower 26. A strap 29 is used to secure the tower 26 to the frame 22 of the plow. In use, as the plow is pulled, the shank 24 engages with the ground. When the shank 24 contacts an obstruction, the shank 24 pivots at the pivotable tower connection, which allows the shank 24 to further compress the spring 28 and move upwards to move past the obstruction.

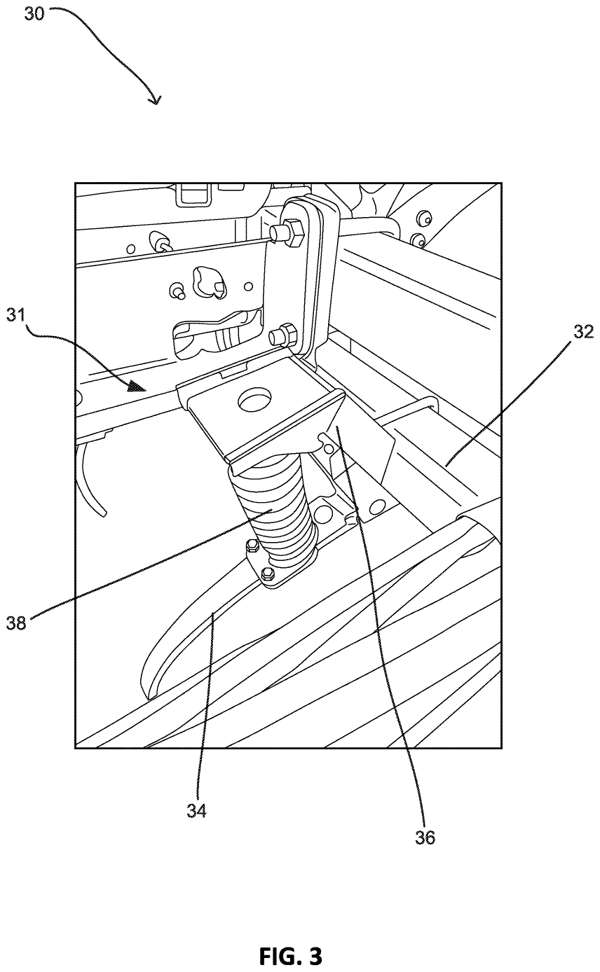

Referring to FIG. 3, a vertical spring orientation plow 30 is shown. The plow 30 comprises a vertical spring orientation mounting assembly 31 mounted to a plow frame 32. Vertical plow mounting assembly 30 functions similarly to the horizontal spring plow assembly discussed with reference to FIG. 2, but the spring 38 is mounted substantially vertical between the tower 36 and the shank 34. It is to be appreciated that horizontal and vertical spring plow mounting assemblies may be used either exclusively, or in use with one another on a given plow, depending on the agricultural operation.

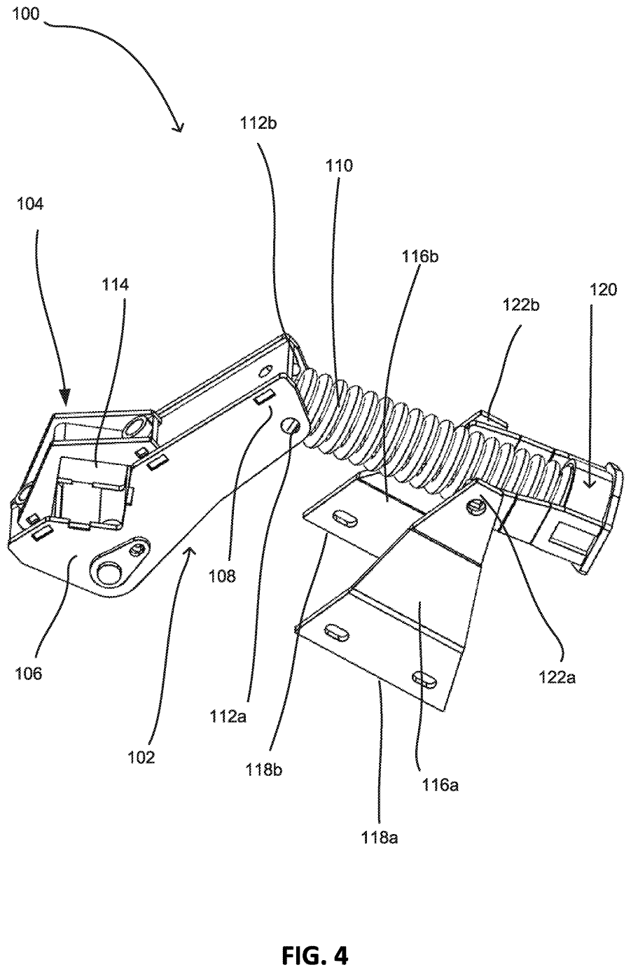

Referring now to FIG. 4, a horizontal spring orientation plow mounting assembly 100 is shown, in accordance with the principles of the present disclosure. The horizontal spring plow mounting assembly comprises a tower 102 and a strap 104 configured to secure a bottom portion 106 of the tower 102 to a frame of the plow. The strap 104 is configured to be removably secured to the bottom portion 106 such that the strap 104 can secure the tower 102 to the frame of the plow. In certain examples, the strap 104 and bottom portion 106 engage with one another to create a substantially square space 114 to fit around a substantially square cross-sectional frame of the plow. In other examples, the strap 104 and bottom portion 106 may be configured to engage with one another to form a different shaped opening that may or may not correspond to the cross-sectional shape of the frame. Further, in certain examples, the strap 104 comprises a u-bolt. In these examples, the bottom portion 106 of the tower 102 can be configured to receive a commercially available u-bolt size.

A top portion 108 of the tower 102 is configured to receive a spring 110. The top portion 108 may define, for example, at least one opening 112 to receive a spring retention mechanism 109, such as a pin or nut and bolt. The spring retention mechanism 109 can engage with both the top portion 108 and the spring 110 to retain the spring within the top portion 108. In certain examples, the spring retention mechanism 109 comprises a bolt that extends through two openings 112a/b in the top portion 108 and through an opening in the spring 110 to retain the spring 110 in the top portion 108. In examples, the spring retention mechanism 109 comprises a 7/8 inch diameter steel bolt with a steel locking nut.

The horizontal spring plow mounting assembly 100 also comprises a pair of mounting arms 116a/b. The mounting arms 116a/b mount to the shank on a first end 118/b and to a spring bracket 120 on a second end 122a/b. The spring bracket 120 receives the spring 110 such that an end of the spring 110 is retained by the top portion 108 of the tower 102 and the other end of the spring 110 is retained by the spring bracket 120. In this way, the spring 110 can be maintained in compression in a generally horizontal position. As shown, the horizontal spring plow mounting assembly 100 maintains the spring 110 at a slightly downward angle, such that the spring 110 can exert a downward force on the shank while compressing and allowing the shank to deflect over top of obstructions as the spring 110 is compressed.

Various size and strength springs may be used, depending on the agricultural operation and particular tower. In examples, the spring may be 110 lbs/inch, 150 lbs/inch, 600 lbs/inch, 900 lbs/inch, or 1200 lbs/inch. In some examples, the spring may be between approximately 100 lbs/inch to 1300 lbs/inch. However, other size and strength springs are considered and may be implemented with the towers of the present disclosure. In examples, a horizontal spring orientation tower may use a stronger spring than a vertical spring orientation tower. In examples, a tower, whether vertical or horizontal spring orientation, may be configured to receive various sized springs. In other examples, the tower, whether vertical or horizontal spring orientation, may be configured and designed to only receive a specific spring size and strength.

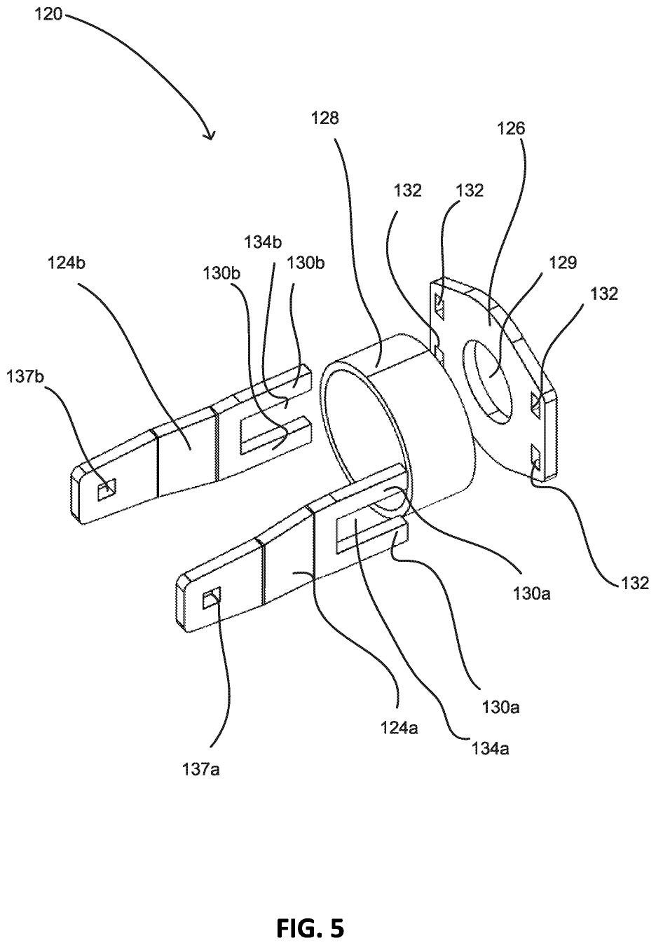

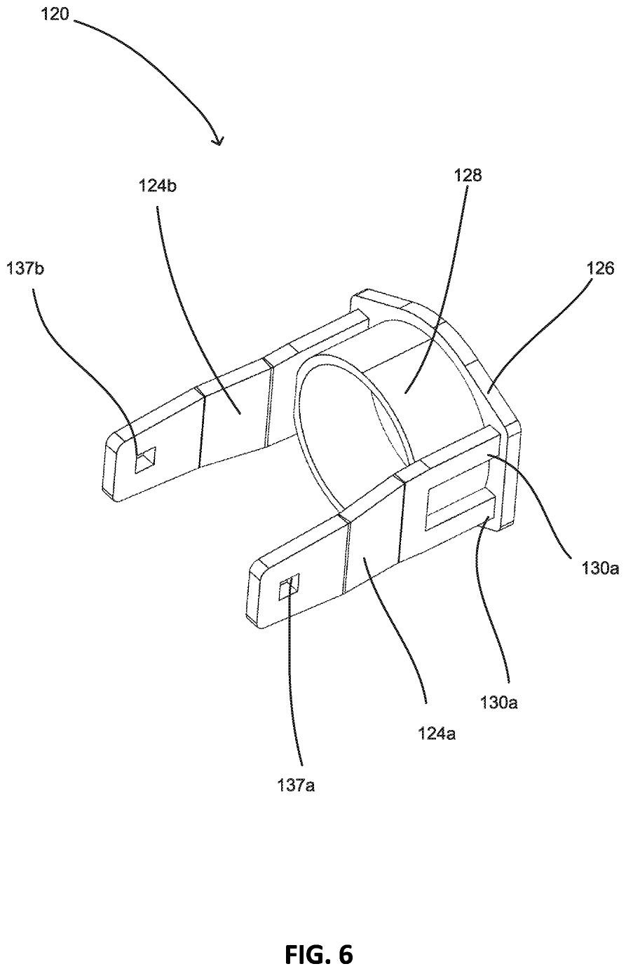

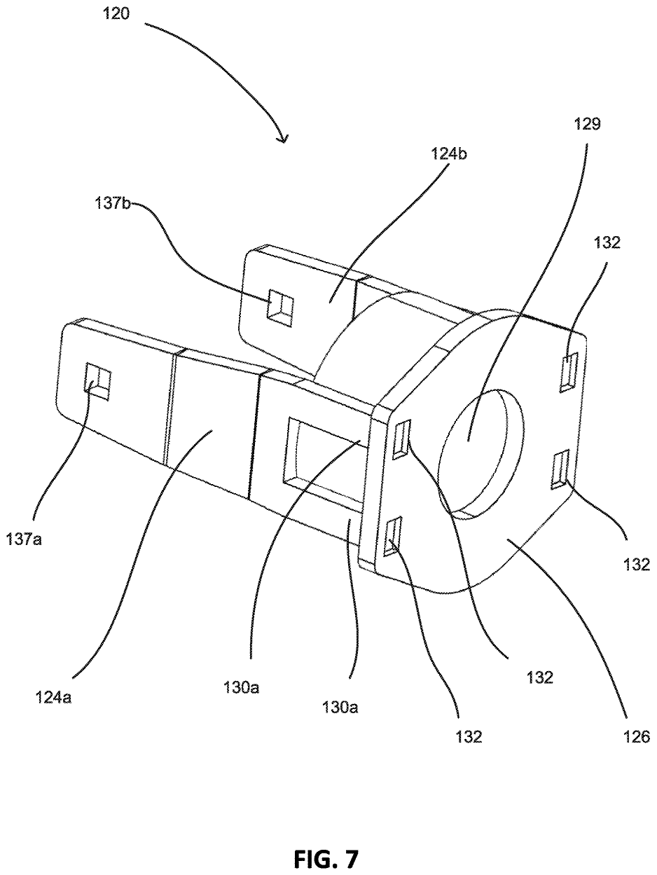

Referring now to FIGS. 5-7, a spring bracket 120 is shown, according to an exemplary implementation. As previously discussed, spring bracket 120 is configured to retain the spring 110, as shown in FIGS. 4 and 5. Spring bracket 120 generally comprises a first and second spring bracket arm 124a and 124b. The spring bracket arms 124a/b are configured to attach to a spring bracket plate 126 and a spring cup 128 is configured to be disposed on the spring bracket plate 126 and between the spring bracket arms 124a/b. The spring bracket plate 126 further defines a spring bracket plate through-hole 129. The spring bracket through-hole 129 is sized to have a diameter smaller than diameters of both the spring and spring cup 128, such that the spring is retained within the spring cup 128 and against the spring bracket plate 126. The through-hole 129 is configured to receive a fastener, like a bolt or screw, and in certain examples, the through-hole 129 comprises a threaded through-hole. The through-hole 129 can be configured to receive the fastener such that the fastener is positioned within the spring. This arrangement can provide radial support to the spring to maintain it in position. In some examples, the fastener can be configured to adjust the compression of the spring.

The spring bracket arms 124a/b can each define at least one prong 130a/b and the spring bracket plate 126 can define a corresponding number of recesses or openings 132. The at least one prong 130a/b is configured to be received by the openings 132 such that an interlocking structure is formed. In examples, and as shown, each spring bracket arm 124a/b comprises two prongs 130a/b such that a gap 134a/b is created between the two prongs 130a/b. In this example, at least a portion of the spring cup 128 can protrude at least partially into the gap 134a/b such that an interlocking of spring bracket arms 124a/b and spring cup 128 is achieved. When assembled, the at least one prong 130a/b can be welded into place in the spring bracket plate openings 132, and the spring cup 128 can be welded to the spring bracket plate 126. The spring cup 128, and entire spring bracket 120, may be sized to accommodate varying spring sizes.

The spring bracket arms 124a/b further comprise mounting features 137a/b configured to mount the spring bracket 120 to the mounting arms. The mounting features 137a/b may comprise, for example, a hole to receive a fastener. Further, as shown, the spring bracket arms 124a/b may be slightly angled such that when assembled, spring bracket arms 124a/b are wider near the mounting feature 137a/b than near the at least one prong 130a/b. This may be advantageous, for example, to allow for more clearance with the spring near the mounting feature 137a/b for easier assembly.

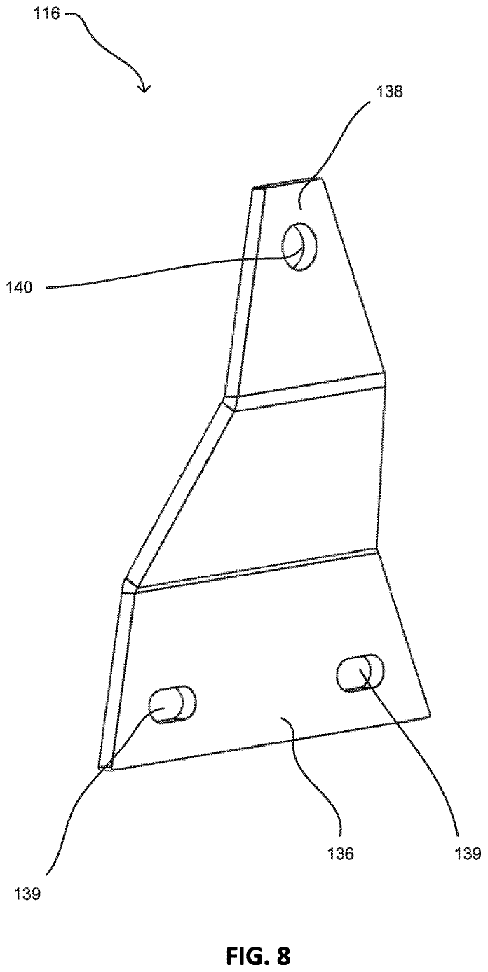

Referring now to FIG. 8, the mounting arm 116 is shown, according to an exemplary implementation. As previously discussed, a first and second mounting arm 116a/b are configured to mount the spring bracket 120 (via the spring bracket arms 124a/b) to the plow. The mounting arm 116 has a bottom portion 136 and a top portion 138 opposite from the bottom portion 136. The bottom portion 136 is configured to be mounted to the plow shank and comprises at least one shank securement feature 139. In an exemplary implementation, the top portion 138 is narrower than the bottom portion 136. As shown, the at least one shank securement feature 139 comprises two holes, which may secure the bottom portion 136 to the shank by fasteners, such as nuts and bolts. Further, the top portion 138 comprises at least one spring bracket securement feature 140 for securing the mounting arms 116a/b to the spring bracket arms 124a/b. In this way, the mounting arms 116a/b attach the spring bracket 120 and spring 110 to the horizontal spring plow mounting assembly 100 such that the plow shank can deflect upwards and compress the spring 110.

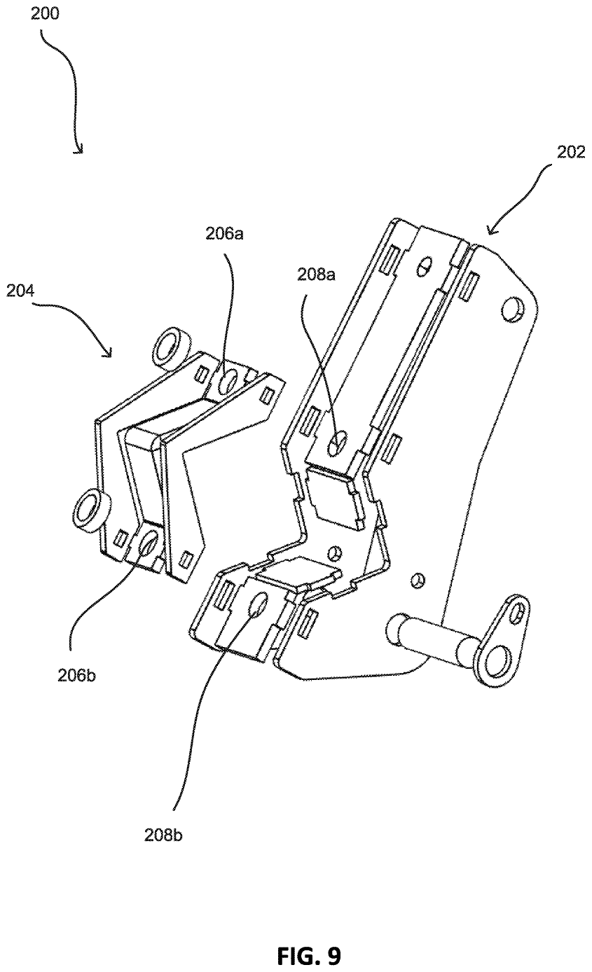

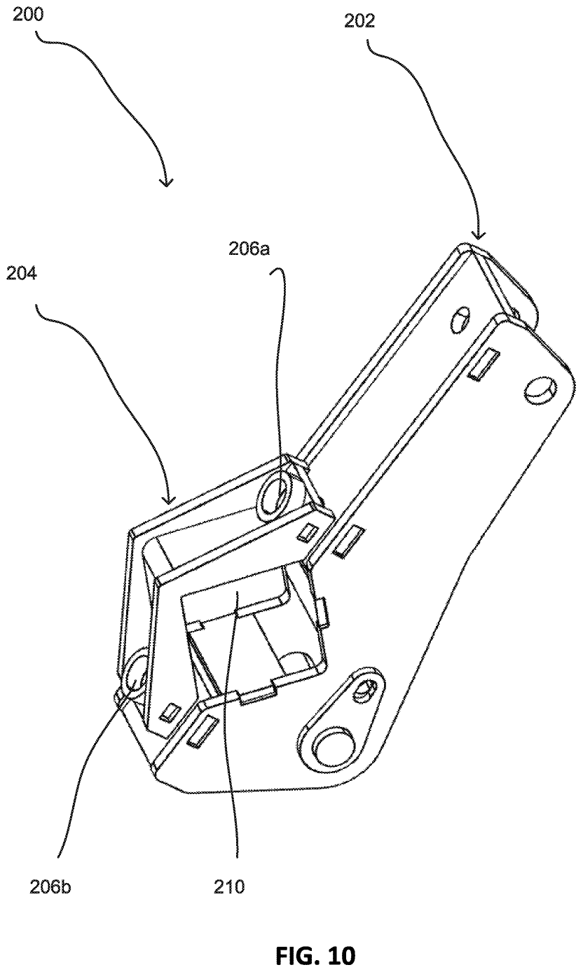

Referring now to FIGS. 9 and 10, a first implementation of a horizontal spring orientation frame-engaging assembly 200 is shown, according to examples. Frame-engaging assembly 200 generally comprises a tower 202 and a strap 204. In examples, the strap 204 defines a first and second strap fastener opening 206a/b. The tower 202 also comprises a first and second tower fastener opening 208a/b configured to align with strap fastener openings 206a/b, respectively. Fastener openings 206a/b and 208a/b are configured to receive a fastener, such as a bolt or screw so that the tower 202 and strap 204 can be removably secured to one another to create a space 210 between the tower 202 and strap 204. As shown, the strap 204 and tower 202 are shaped to create a substantially square space 210 to be mounted to a substantially square cross-sectional frame. However, in other implementations, the strap 204 and tower 202 can be designed to create other shaped spaces to engage the frame in a way that prevents rotation of the frame engaging assembly 200 around the frame. Further, in some implementations, strap 204 may comprise a u-bolt, and the tower 202 can be configured to receive the u-bolt through the first and second tower fastener openings 208a/b.

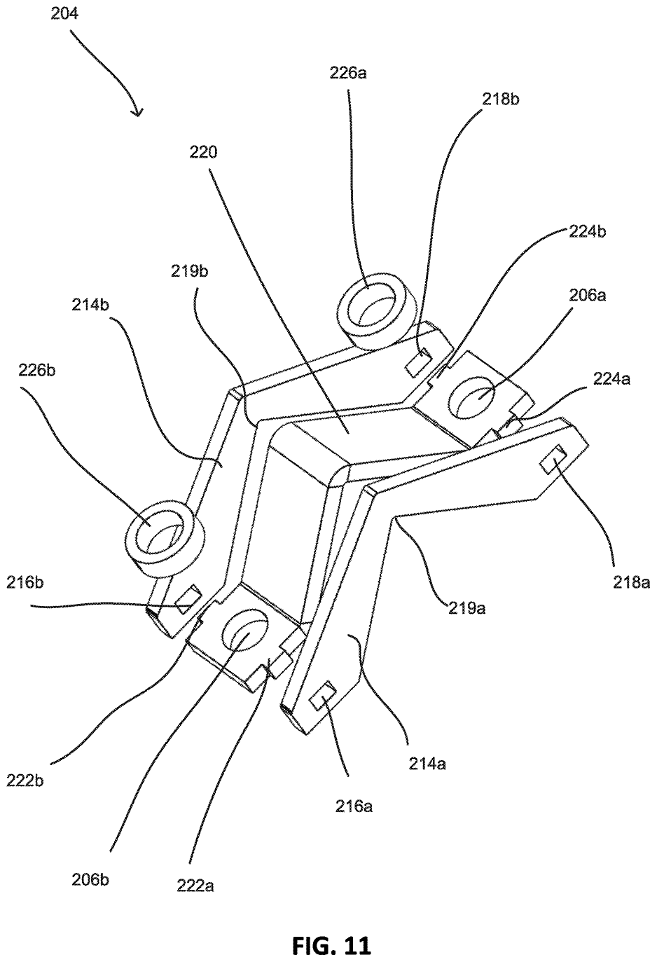

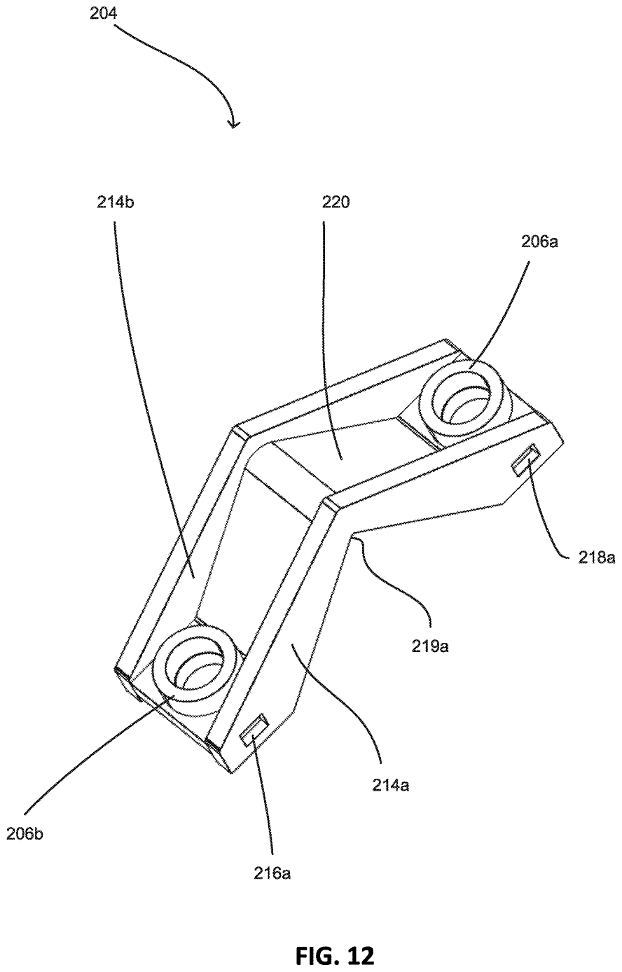

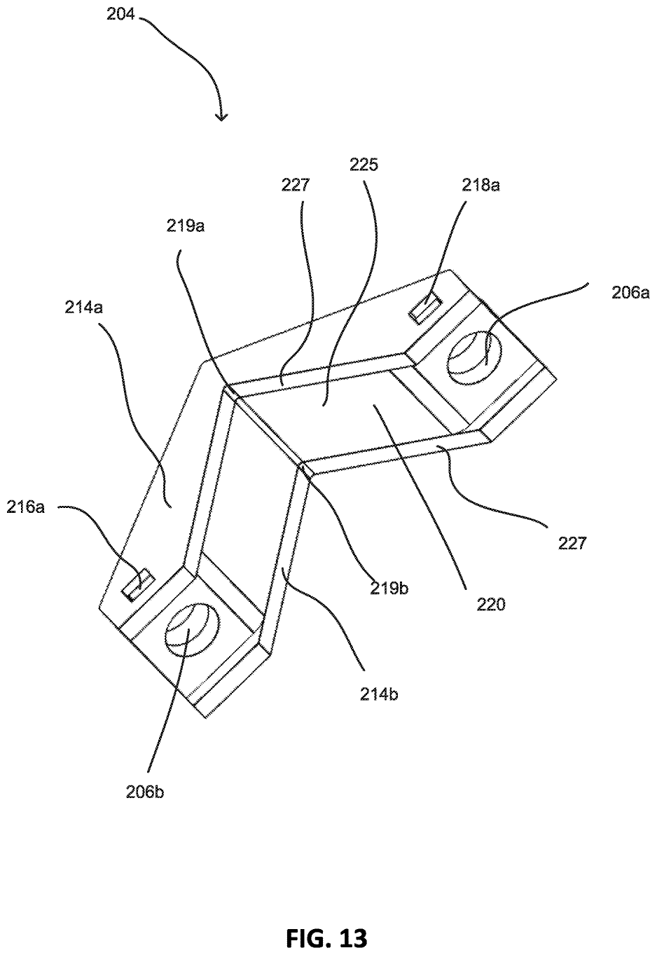

Referring now to FIGS. 11-13, the strap 204 of frame-engaging assembly 200 is shown in greater detail. Strap 204 comprises a first and second strap sidewall 214a/b. As shown, the first and second strap sidewalls 214a/b define a plurality of strap engagement features 216a/b and 218a/b. In certain examples, strap sidewalls 214a/b define two engagement features 216a/b and 218a/b near end portions of both strap sidewalls 214a/b. However, alternate arrangements are considered. For example, strap sidewalls 214a/b could define, either in addition to or as an alternative, engagement features further inside from the end portions of the strap sidewalls 214a/b. Further, in an exemplary implementation, strap sidewalls 214a/b define a substantially perpendicular corner 219a/b configured to engage with a substantially perpendicular corner of the plow frame. When the strap 204 is secured to the tower 202 around the frame, such a design may prevent rotation of the frame-engaging assembly 200 around the frame.

Strap sidewalls 214a/b are separated from one another by, and affixed to, a strap sidewall conjoining member 220. Strap sidewall conjoining member 220 defines a generally similar profile as the strap sidewalls 214a/b and defines a first and second strap fastener opening 206a and 206b. As previously described, the strap fastener openings 206a/b are configured to receive a fastener to secure the strap 204 to the tower. Such fastener can comprise, for example, a bolt and nut, a screw, or some configuration of a locking pin. In some examples, the strap fastener openings 206a/b may be threaded to engage with a bolt or screw.

Further, strap sidewall conjoining member 220 defines a plurality of strap securing elements 222a/b and 224a/b that are configured to secure the strap sidewall conjoining member 220 to the strap sidewalls 214a/b through an interface between the strap securing elements 222a/b and 224a/b and strap engagement features 216a/b and 218a/b. As shown in FIG. 11, for example, securing elements 222a and 224a are configured to be secured to strap sidewall 214a through the sidewall engagement features 216a and 218a, respectively. Similarly, strap securing elements 222b and 224b are configured to be secured to strap sidewall 214b through the sidewall engagement features 216b and 218b, respectively.

As shown, the strap securing elements 222a/b and 224a/b are disposed near ends of the strap sidewall conjoining member 220. However, like the sidewall engagement features 216a/b and 218a/b, the strap securing elements 222a/b and 224a/b can be disposed elsewhere along the strap sidewall conjoining member 220 to align with the positioning of the sidewall engagement features 216a/b and 218a/b.

In an exemplary implementation, the strap securing elements 222a/b and 224a/b affix the strap sidewall conjoining member 220 to the strap sidewalls 214a/b via an interlocking connection with the strap sidewall engagement features 216a/b and 218a/b. As shown in FIG. 11, for example, the strap securing elements 222a/b and 224a/b define protrusions extending outward and the strap sidewall engagement features 216a/b and 218a/b define cutouts. The cutouts may be open ended, or they may be fully enclosed openings, as shown. In this example, the strap sidewall conjoining member 220 connects the strap sidewalls 214a/b via an interlocking engagement, that is, the openings receive the protrusions. In this exemplary implementation, the pieces can then be welded together to permanently affix the strap sidewalls 214a/b and strap sidewall conjoining member 220 to one another. In this example, the weld can be made between the strap sidewall conjoining member 220 and strap sidewalls 214a/b only where protrusions and openings interlock. An exemplary advantage of this weld arrangement is that the remainder of the strap sidewall conjoining member 220 is not rigidly affixed to the sidewalls 214a/b and can bend under sufficient force. This may reduce the likelihood of weld failures from over-rigidity. However, in other implementations, the weld can be made along the entire length of the interface between the strap sidewalls 214a/b and strap sidewall conjoining member 220.

In other examples, the strap securing elements 222a/b and 224a/b and strap sidewall engagement features 216a/b and 218a/b can interface differently. For instance, in certain examples, the strap securing elements 222a/b and 224a/b can define cutouts configured to receive protrusions defined by the strap sidewall engagement features 216a/b and 218a/b. In other examples, the strap sidewall engagement features 216a/b and 218a/b can define slots in the strap sidewalls 214a/b and the strap securing elements 222a/b and 224a/b can define protrusions configured to be received by the slots. Alternative interlocking connection methods between the strap securing elements 222a/b and 224a/b and strap sidewall engagement features 216a/b and 218a/b may be used, with or without welding, to affix the strap sidewalls 214a/b to the strap sidewall conjoining member 220.

In examples, and as shown, the strap securing elements 222a/b and 224a/b and sidewall engagement features 216a/b and 218a/b are configured to interlock such that a bottom surface 225 of the sidewall conjoining member 220 is flush with a bottom edge 227 of the first and second strap sidewalls 214a/b. This arrangement may be advantageous, for example, to increase the contact surface area with the frame to better distribute forces. This can result in decreased wear on both the frame and the strap 204, as well as provide a stronger frame engaging assembly 200 than one that utilizes a u-bolt.

In some examples, strap 204 may further comprise a first and second strap bushing 226a/b positioned to align with the first and second strap fastener openings 206a/b, respectively. The strap bushings 226a/b may be affixed to the strap sidewall conjoining member 220 by welding, for example. The strap bushings 226a/b are configured to receive a fastener to secure the strap 204 to the tower 202. As an exemplary advantage, the strap bushings 226a/b may alleviate wear on the strap conjoining member 220, better distribute stress loads, and/or lengthen the through-hole to better receive a standard sized bolt. Further, the strap bushings 226a/b may advantageously raise the head of a bolt to accommodate a socket drive, for example.

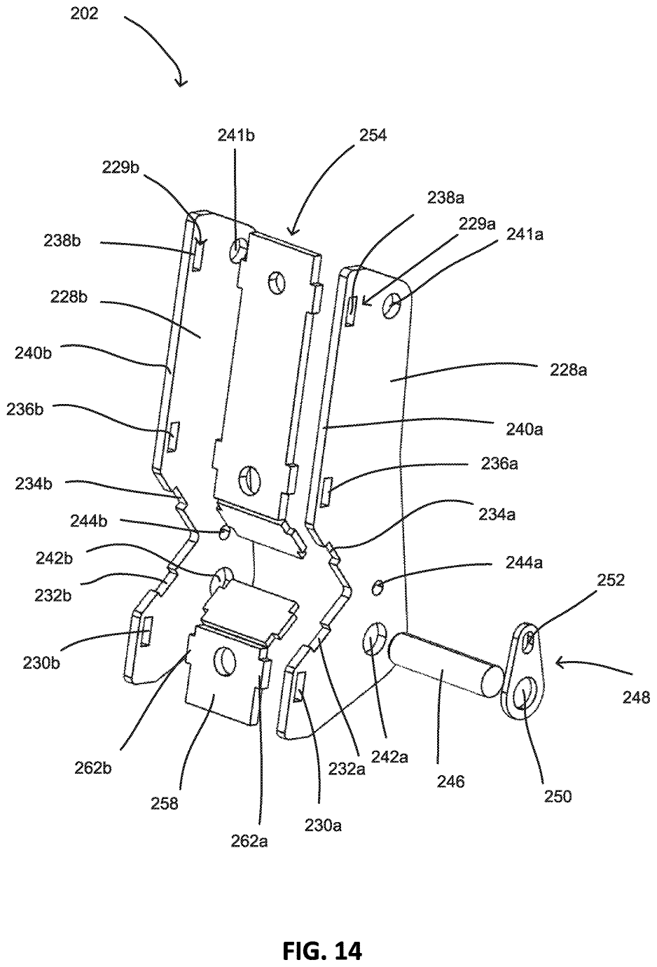

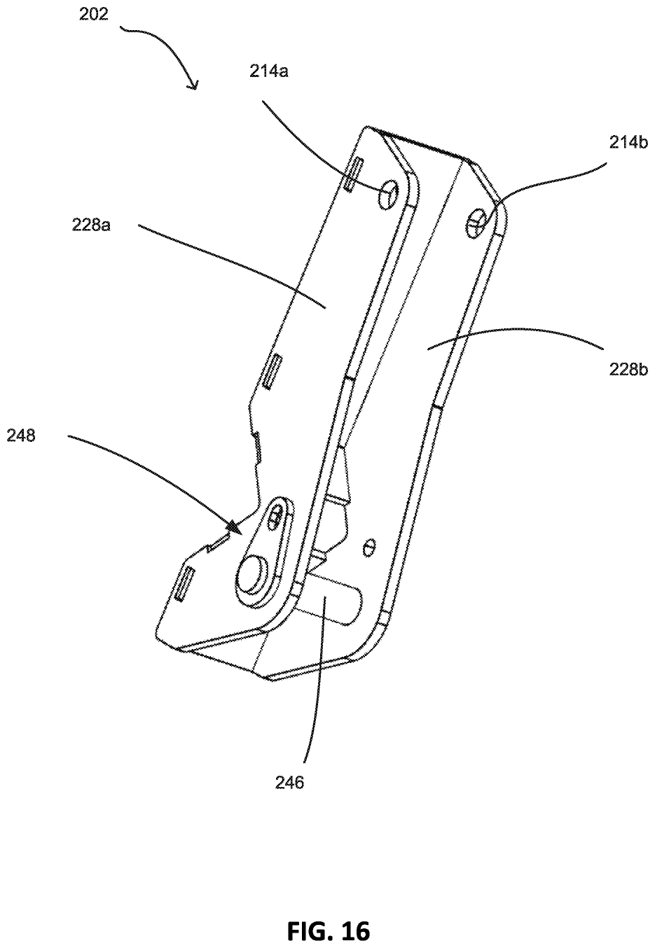

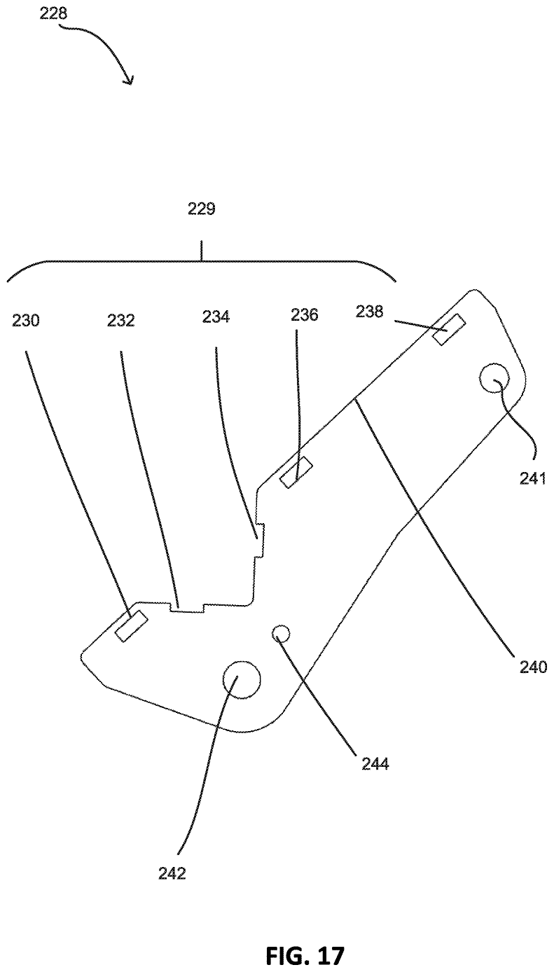

Referring generally now to FIGS. 14-17, the tower 202 of FIGS. 9-10 are shown, in accordance with the principles of the present disclosure. The tower 202 comprises a first and second tower sidewall 228a/b. The tower sidewalls 228a/b define a plurality of first tower sidewall engagement features 229a and a plurality of second tower sidewall engagement features 229b. As shown, the plurality of engagement features 229a/b comprises five engagement features 230a/b, 232a/b, 234a/b, 236a/b, and 238a/b along or near a front edge 240a/b of the tower sidewalls 228a/b. However, more or fewer tower sidewall engagement features may be used, and they may be arranged along the tower sidewalls 228a/b differently than as shown. Further, the plurality of tower sidewall engagement features 229a/b may comprise cutouts, which can include fully enclosed slots like engagement features 230a/b, 236a/b, and 238a/b, open-ended slots like engagement features 232a/b and 234a/b, or a combination as shown. Further, any number of the plurality of tower sidewall engagement features 229a/b may be located further inward from the front edge 240a/b.

The tower sidewalls 228a/b also define a spring retaining opening 241a/b. The spring retaining opening 241a/b is configured to receive a retention mechanism, such as a screw, nut and bolt, or pin, to retain the spring between the tower sidewalls 228a/b. The retention mechanism (not pictured) provides a structure that, in combination with the spring bracket, maintains the spring under compression such that the spring can provide a downward force on the plow shank.

The tower sidewalls 228a/b further define a pivot pin receiving hole 242a/b and a pivot pin locking feature 244a/b. The pivot pin receiving holes 242a/b are configured to receive a pivot pin 246 that extends through both tower sidewall 228a/b pivot pin receiving holes 242a/b. In use, the pivot pin 246 retains the shank of the plow within the tower and provides a pivot axis for the shank so that the shank may pivot around the pivot pin 246 and deflect upwards when the shank encounters an obstruction. In certain examples, the pivot pin 246 (and subsequently discussed pivot pin variations) is a zinc plated steel pin, which may prevent the pivot pin 246 from seizing to the shank. In certain examples, the pivot pin 246 (and subsequently discussed pivot pin variations) is a 1 inch, 1.125 inch, or 1.25 inch diameter pivot pin. In certain examples, the pivot pin 246 (and subsequently discussed pivot pin variations) is a 2.75 inch, 4 inch, or 4.125 inch length pivot pin. In examples, a certain pivot pin diameter and length may be used with multiple implementations of towers.

A pivot pin locking bracket 248 is configured to retain the pivot pin 246 within the pivot pin receiving holes 242a/b. The pin locking bracket 248 comprises a pin receiver 250 configured to receive the pivot pin 246 and a pin securing feature 252. The pin securing feature 252 is configured to interface with either or both pivot pin locking feature 244a/b to retain the pin locking bracket 248, and pivot pin 246, to the tower sidewall 228a/b such that the pivot pin 246 remains in place within the pivot pin receiving holes 242a/b.

In an exemplary implementation, and as shown, the pivot pin locking feature 244a/b and pin securing feature 252 both comprise through-holes that are configured to align with one another. A fastener or other retaining mechanism can then be used to secure the pivot pin locking bracket 248 to the tower sidewall 228a/b by interfacing with the aligned pivot pin locking bracket 248 and tower sidewall 228a/b through-holes. This may use, for example, a locking nut and a bolt. Further, it is to be appreciated that in examples, the pin locking bracket 248 can secure the pivot pin 246 within the tower sidewalls 228a/b by being affixed to either tower sidewall 228a or 228b by utilizing either pivot pin locking feature 244a or 244b. This may be advantageous, for example, because the plow frame or other obstacles may make installation from one side of the tower assembly impossible or more difficult than installation from the other side of the tower assembly. In examples, the fastener comprises a ½ inch flanged and 2 inch long bolt and a steel top lock nut.

In an exemplary implementation, the pivot pin locking bracket 248 prevents the pivot pin 246 from rotating, that is, the pin 246 is non-rotatably received within the pin receiver 250. This may be accomplished, for example, by welding the pin 246 into the pin receiver 250. However, alternative methods are considered. For example, a portion of the pin 246 and pin receiver 250 may comprise a geometry with at least one flat edge to prevent rotation, or other anti-rotation mechanisms may be used such as set screws or a locking pin. An exemplary advantage of a non-rotatable pivot pin 246 is that the shank will rotate around the pivot pin 246, instead of the pivot pin 246 rotating within the sidewall pivot pin receiving holes and pivot pin locking bracket. Accordingly, the pivot pin 246 will experience wear faster than the tower sidewalls 228a/b, which is advantageous because replacing the pivot pin 246 is generally cheaper and easier than replacing the entire tower assembly. Further, as shown, the pin receiver 250 comprises a through-hole, but it is to be appreciated that other pin receiving configurations may be used. For example, the pin receiver 250 may comprise a recessed portion or other geometry to receive the pin 246 without defining a complete through-hole.

Referring to FIGS. 14-16 and FIGS. 18-20, tower 202 further comprises a tower sidewall conjoining arrangement 254 configured to be affixed between the first and second tower sidewalls 228a and 228b. In examples, and as shown, the tower sidewall conjoining arrangement 254 comprises an upper conjoining member 256, a lower conjoining member 258, and two frame engaging conjoining members 260a/b disposed between the upper and lower conjoining members 256 and 258.

Each member of the tower sidewall conjoining arrangement 254 comprises at least one first tower sidewall securing element 262a and at least one second tower sidewall securing element 262b. The at least one first tower sidewall securing element 262a is configured to secure the conjoining member to the first sidewall engagement features 229a of the first tower sidewall 228a. The at least one second tower sidewall securing element 262b is configured to secure the conjoining member to the second sidewall engagement features 229b of the second tower sidewall 228b. In some examples, and as shown, the sidewall securing elements 262a/b comprise outward extending protrusions and the sidewall engagement features 229a/b comprise a combination of enclosed and open-ended openings to receive the protrusions. However, other configurations are considered. In other examples, the sidewall securing elements 262a/b can comprise protrusions and the sidewall engagement features 229a/b can comprise additional structure to interlock with the protrusions. In other examples, the sidewall securing elements 262a/b can comprise cutouts such as openings or slots and the sidewall engagement features 229a/b can comprise protrusions to be received by the sidewall securing elements 262a/b.

In general, the sidewall securing elements 262a/b and sidewall engagement features 229a/b are configured in a way such that they interlock with one another to create an interlocking assembly. Such an interlocking assembly may have advantages over a cast one-piece design. For example, it may be simpler and cheaper to manufacture and assemble the individual pieces than it is to cast the entire structure. Further, the interlocking design may be more resilient to wear and fatigue failure because, for example, it can create a less rigid design that can deform to better handle high stress loads. In an exemplary implementation, the interlocking assembly is fixed in position by welding. In some examples, the weld is discontinuous along the length of the assembly, such that the there are welds along the interlocking interface between the sidewall securing elements 262a/b and sidewall engagement features 229a/b. There can also be strengthening welds in high stress areas, such as corners. In other examples, the entire length of contact between the tower sidewall conjoining arrangement 254 and tower sidewalls 228a/b can be welded together.

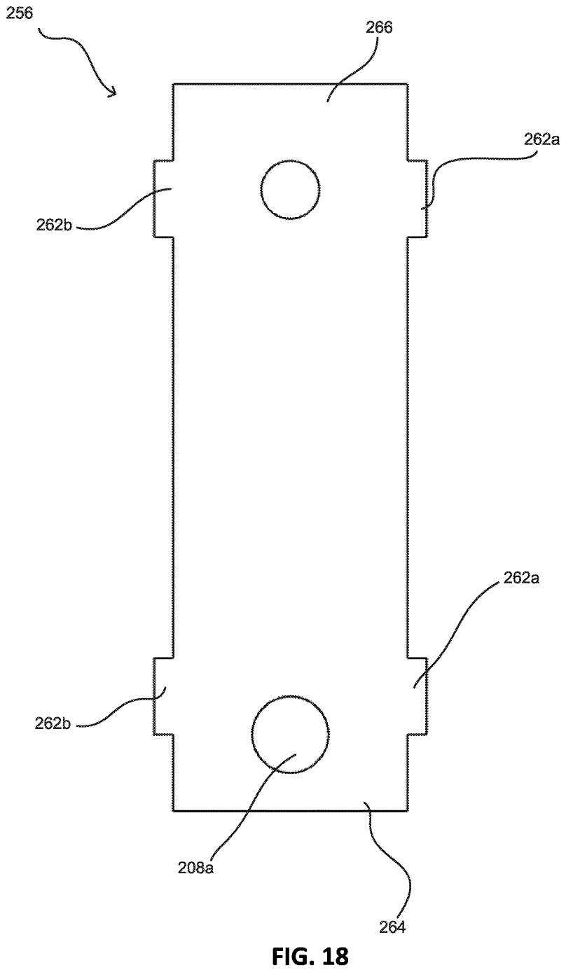

Referring now to FIG. 18 the upper tower conjoining member 256 is shown, according to an exemplary implementation. The upper tower conjoining member 256 defines a first tower fastener opening 208a near a bottom end 264 of the upper tower conjoining member. The first tower fastener opening 208a is configured to align with the first strap fastener opening 206a to secure the strap 204 to the tower 202, via securement to the upper tower conjoining member 256. As previously discussed, the strap 204 can be secured to the upper tower conjoining member 256 though a retention mechanism such as nut and bolt or pin. In examples, the at least one first side tower sidewall securing element 262a comprises two protrusions and the at least one second side tower sidewall securing element 262b comprises two protrusions. In these examples, two of the protrusions are proximate the bottom end 264 and two of the protrusions are proximate a top end 266. However, in other examples, additional tower sidewall securing elements 262a/b can be added. For example, additional protrusions could be added near a middle portion of the upper tower conjoining member 256.

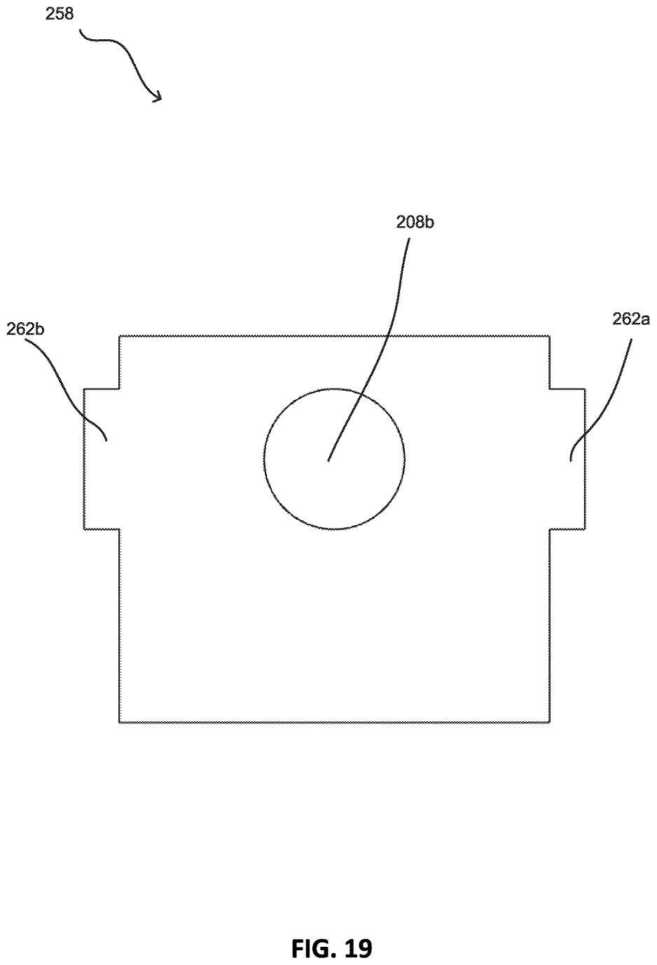

Referring now to FIG. 19, a lower tower conjoining member 258 is shown, according to an exemplary implementation. The lower tower conjoining member 258 defines a second tower fastener opening 208b configured to align with the second strap fastener opening 206b to secure the strap 204 to the tower 202, via securement to the lower tower conjoining member 258. As previously discussed, the strap 204 can be secured to the lower tower conjoining member 258 though a retention mechanism such as locking nut and bolt or pin. In examples, the at least one first and second side tower sidewall securing elements 262a/b comprise one protrusion on each side of the lower tower conjoining member 258. In examples, the protrusions are located proximate the second tower fastener opening 208b, which may advantageously support a force around the second tower fastener opening 208b when the strap 204 is fastened to the tower 202.

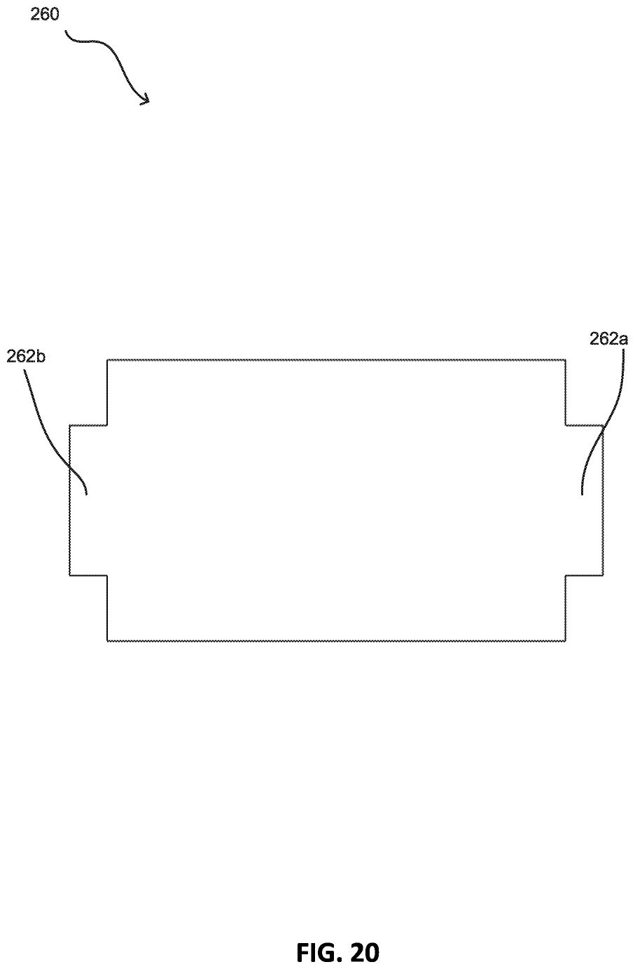

Referring now to FIG. 20, the frame engaging conjoining member 260a/b is shown, according to an exemplary implementation. In some examples, a first and second frame engaging conjoining member 260a/b are configured to be affixed to the first and second tower sidewalls 228a/b between the upper and lower tower conjoining members 256 and 258. In these examples, the tower sidewalls 228a/b can define a substantially 90-degree angle such that the first and second frame engaging conjoining members 260a/b are positioned perpendicular to one another and can engage with a generally rectangular or square plow frame. In this manner, the profile of the tower sidewalls 228a/b, frame engaging conjoining members 260a/b and shape of the strap 204 create a space 210 shaped as desired to fit around the frame.

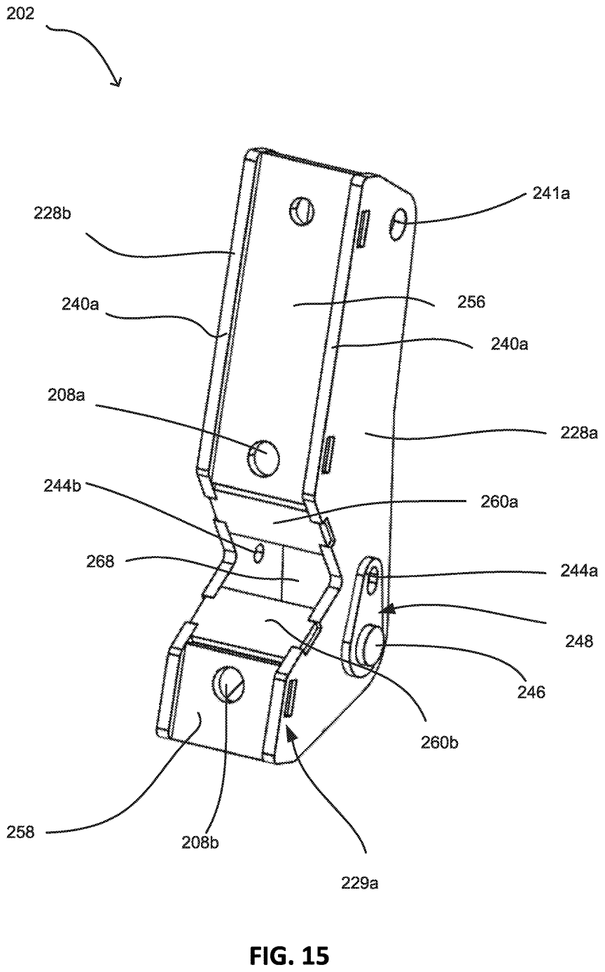

In examples, the first and second frame engaging conjoining members 260a/b have one first and second side sidewall securing elements 262a/b configured as protrusions. In an exemplary implementation, the corresponding first and second sidewall engagement features 229b are configured to be open ended slot cutouts. As an exemplary advantage of such a configuration, when the slots of the tower sidewalls 228a/b receive the protrusions of the frame engaging conjoining members 260a/b, the frame engaging conjoining members 260a/b are positioned to be flush with the front edge 240a/b of the sidewalls 228a/b. As such, the entire face of the frame engaging conjoining members 260a/b can engage the plow frame, which allows the force to be spread over a greater area. This can reduce wear on both the frame and the tower 202. As shown, in some examples, the first and second frame engaging conjoining members 260a/b leave a gap 268 between them, as seen in FIG. 15. In other examples, the frame engaging conjoining members 260a/b are sized to substantially abut one another such that there is substantially no gap.

While certain examples of tower sidewall conjoining arrangements 254 have been shown and described, it is to be appreciated that other configurations can be achieved and are considered within the scope of this disclosure. For example, any of the individual parts of the tower sidewall conjoining arrangement 254 could be combined with one another. For example, the entire tower sidewall conjoining arrangement 254 could combine the upper conjoining member 256, lower conjoining member 258, and two frame engaging conjoining members 260a/b into a single piece. Alternatively, any combination of pieces is considered: upper conjoining member 256 combined with first frame engaging conjoining member 260a and lower conjoining member 258 combined with second frame engaging conjoining member 260b; lower conjoining member 258 combined with both first and second frame engaging conjoining members 260a/b; upper conjoining member 256 combined with first and second frame engaging conjoining members 260a/b; frame engaging conjoining members 260a/b combined with one another, etc.

Further in some examples, the tower sidewalls 228a/b are powder coated steel. In some examples, the tower sidewall conjoining arrangement is comprised of powder coated steel. In examples, the tower sidewalls 228a/b and conjoining plate arrangement 254 comprise ⅜ inch grade 80 steel. In other examples, the tower sidewalls 228a/b and conjoining plate arrangement 254 comprise ¼ inch grade 80 steel. In other examples, the tower sidewalls 228a/b may be made of a different thickness steel than the conjoining plate arrangement 254. These examples are intended to be nonlimiting, and additional thicknesses of tower sidewalls and conjoining arrangements may be used in accordance with the present disclosure.

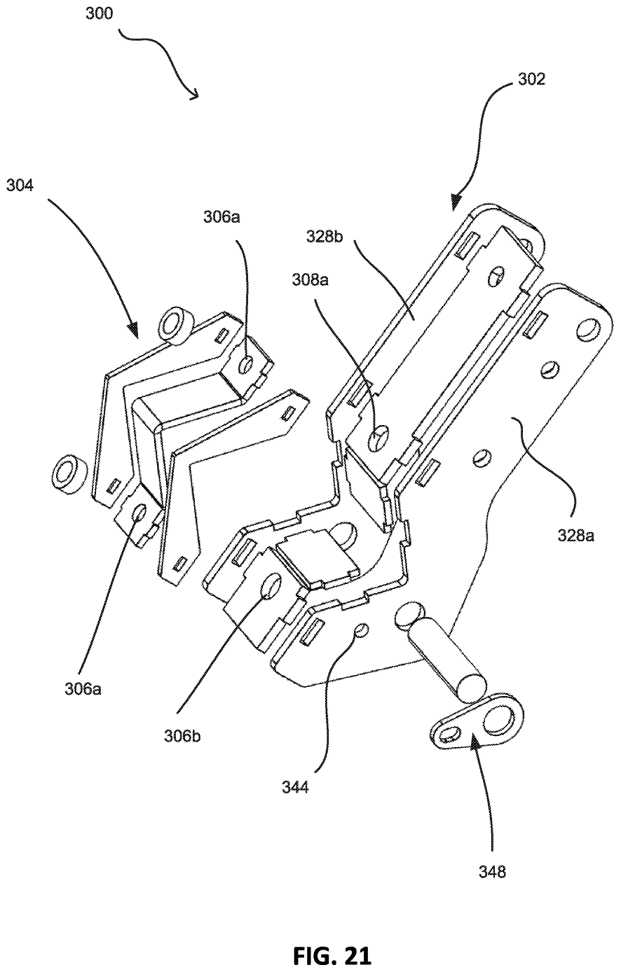

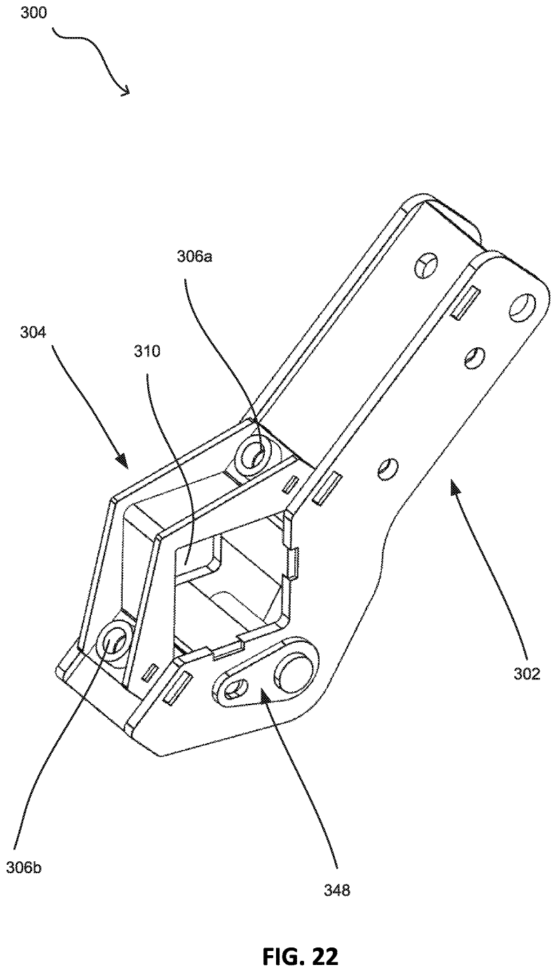

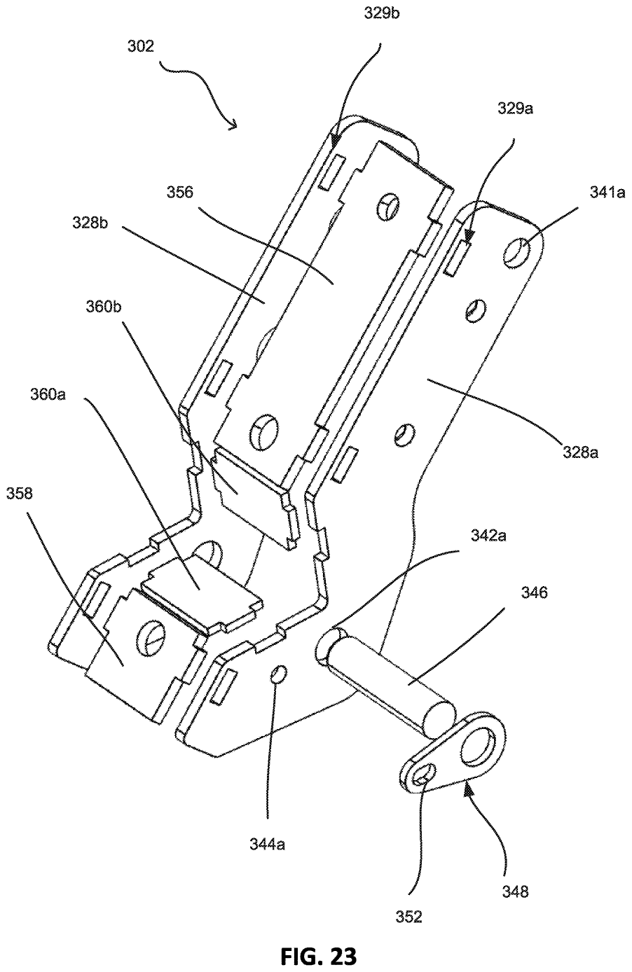

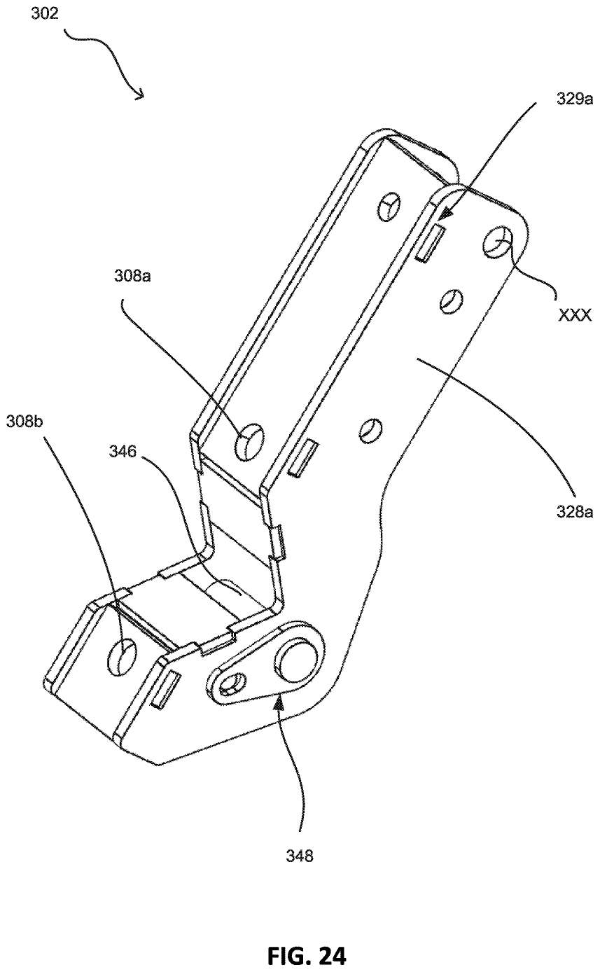

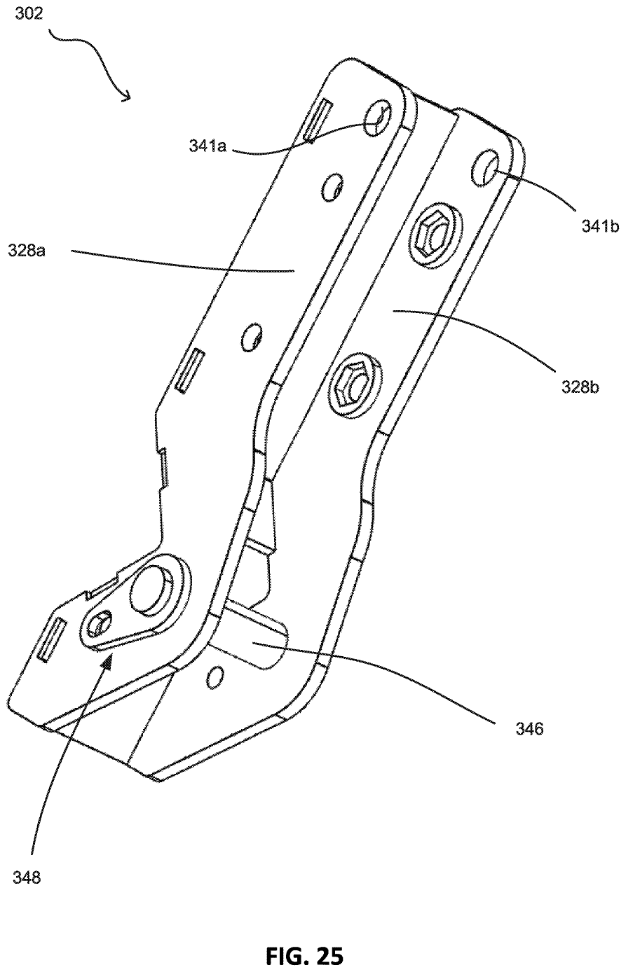

Referring now to FIGS. 21-25, a second implementation of a horizontal spring orientation frame engaging assembly 300 and tower 302 is shown, according to examples. Frame engaging assembly 300 shares many similarities with the previously discussed frame engaging assembly 200, and similar elements will be iterated by 100. For example, tower 302 generally corresponds to tower 202 and strap 304 generally corresponds to strap 204.

Frame engaging assembly 300 may differ from frame engaging assembly 200 in several respects. For example, the tower 302 and strap 304 may be configured to create a different size or shape space 310 to accommodate a different size or shape plow frame. Also, the tower sidewall conjoining arrangement 354 could be wider, such that the first and second tower sidewalls 328a/b are spaced further apart and may accommodate a larger spring, for example. Similarly, the tower 302 could be taller or angled differently to accommodate various springs or plow models. As another noticeable difference, the pivot pin locking bracket 348 is configured to be installed in a different orientation along one of the tower sidewalls 328a/b, due to the location of the pivot pin locking feature 344. As shown, the pivot pin locking bracket 348 is configured to be installed substantially horizontal.

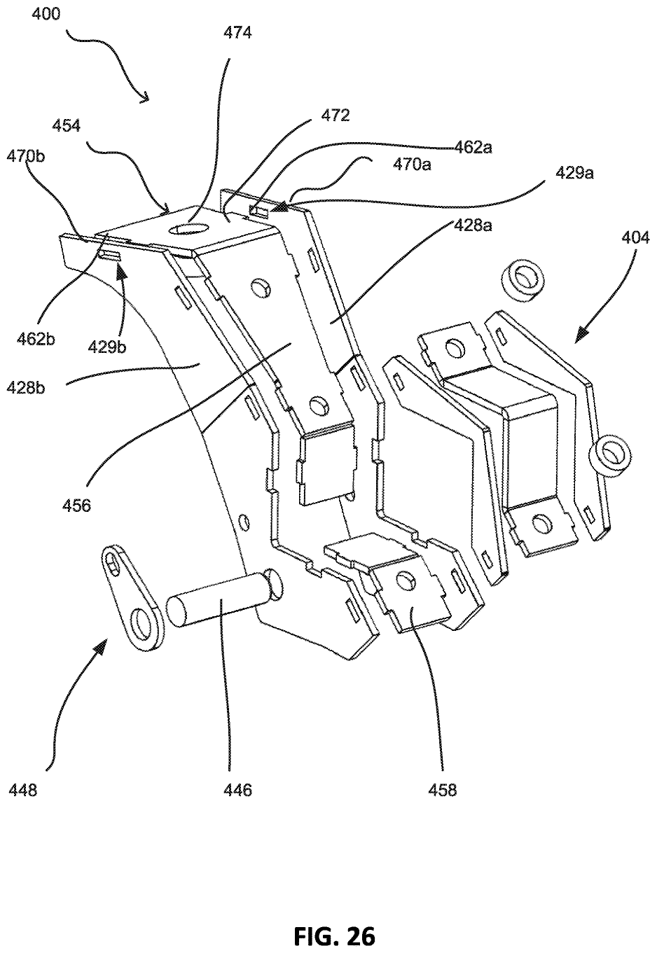

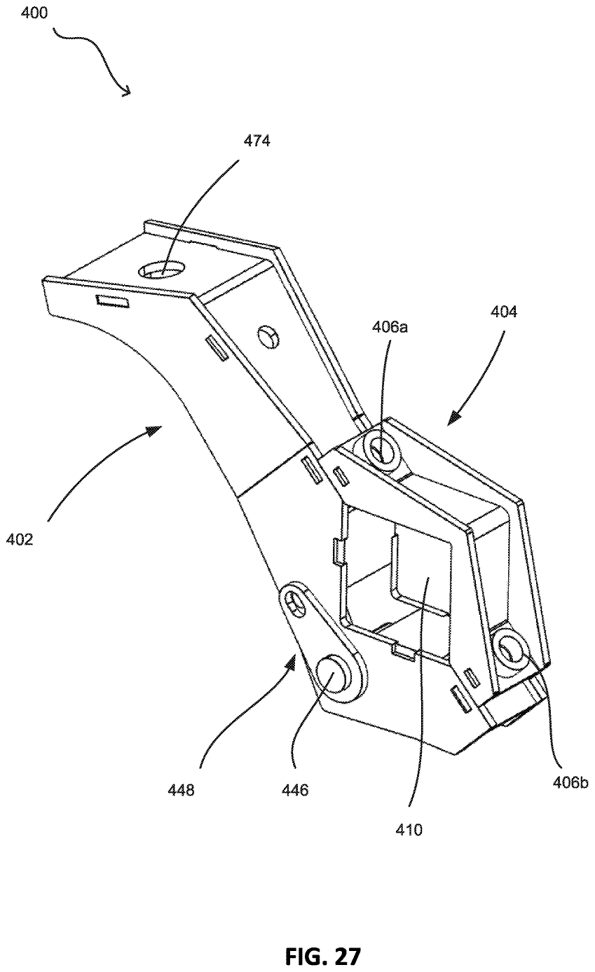

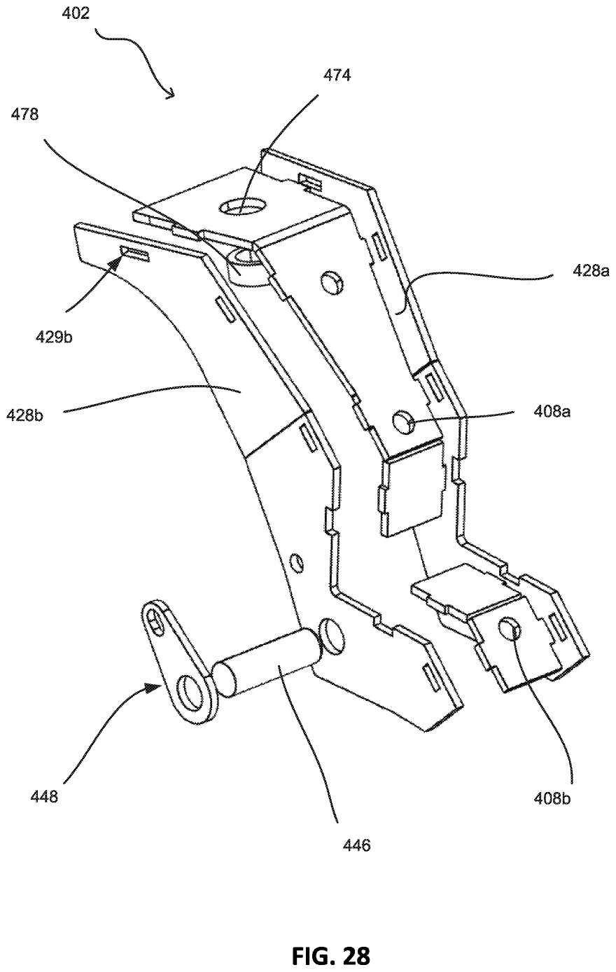

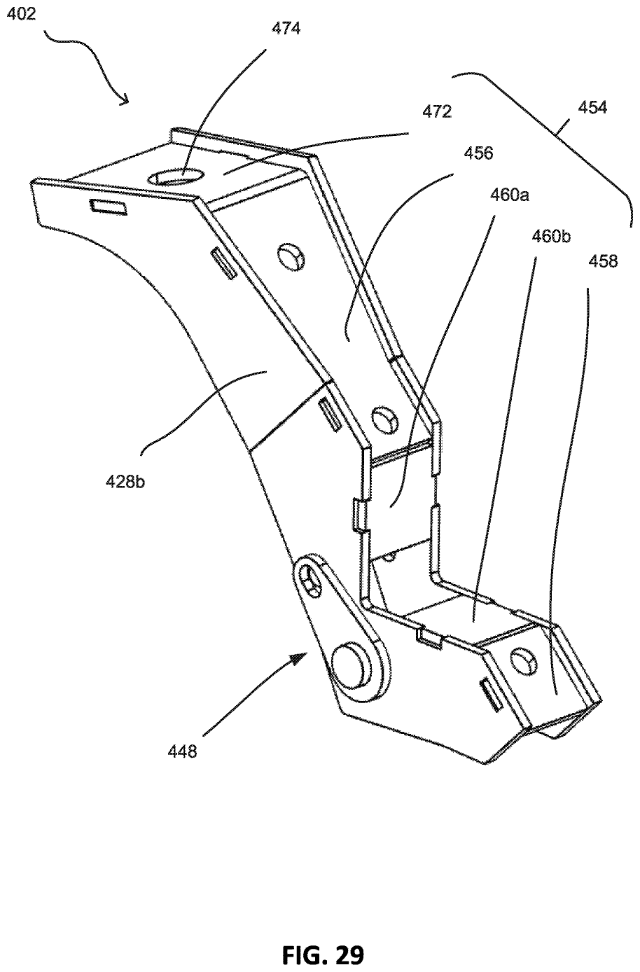

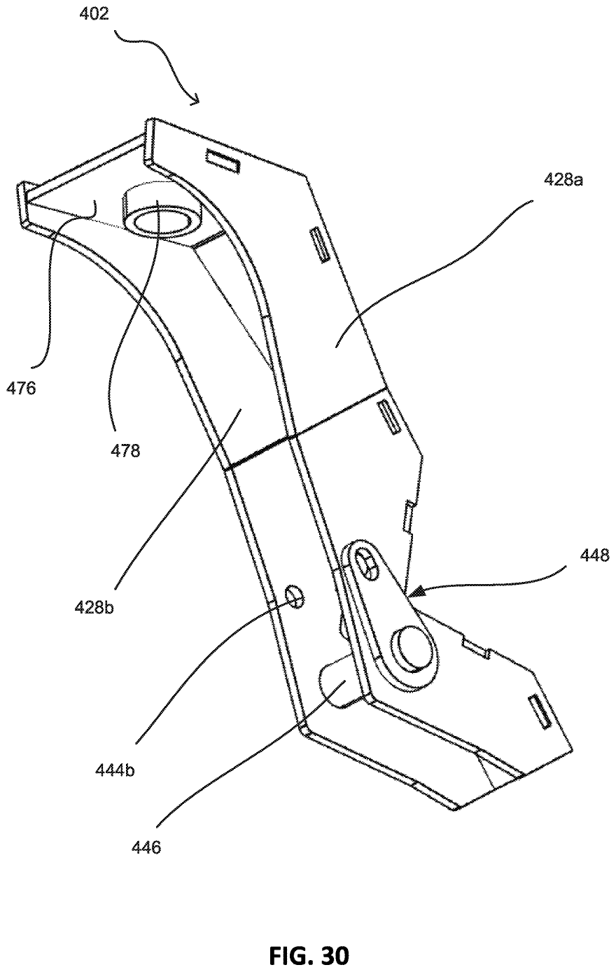

Referring now to FIGS. 26-30, a first implementation of a vertical spring orientation frame engaging assembly 400 and tower 402 is shown, according to examples. Frame engaging assembly 400 shares many similarities with the previously discussed frame engaging assemblies, and similar elements will be numbered similarly and iterated by 100.

Frame engaging assembly 400 mainly differs from those previously discussed because it is configured for a vertical spring orientation. Accordingly, the first and second tower sidewalls 428a/b define a substantially horizontal edge 470a/b, configured to be positioned substantially horizontal when the frame engaging assembly 400 is installed around a plow frame. Similarly, the tower sidewall conjoining arrangement 454 defines a substantially horizontal conjoining member 472, configured to connect with the substantially horizontal edge 470a/b. As previously described, this connection can be made by an interface between at least one tower sidewall securing element 462a/b on the substantially horizontal conjoining member 472 and at least one corresponding engagement feature 429a/b near the horizontal edge 470a/b of the first and second tower sidewalls 428a/b.

The substantially horizontal conjoining member 472 further comprises a spring engagement hole 474, an underside 476, and a spring retainer 478 affixed to the underside 476. The underside 476 is configured to support one end of a compressed spring, while the other end of the spring provides a downward force on the plow shank. Further, in examples, the spring retainer 478 is configured to fit within the spring, to provide radial support and prevent the spring from shifting radially outward. Further still, the spring engagement hole 474 and/or the spring retainer 478 may be threaded, such that it can receive a screw or bolt. The screw or bolt can threadingly engage the spring engagement hole 474 and or spring retainer 478 such that at least a portion of the bolt or screw protrudes into the center of the spring. This may provide additional radial support to the spring and also be configured to adjust the compression of the spring.

As shown, the substantially horizontal conjoining member 472 is part of the upper conjoining member 456. In other examples, the substantially horizontal conjoining member 472 is an additional and separate part of the tower sidewall conjoining arrangement 454. Further, as another exemplary difference between previously described frame engaging assemblies, the tower sidewalls 428a/b and tower sidewall conjoining arrangement 454 are flared, such that the upper conjoining member 456 and substantially horizontal conjoining member 472 are wider than the lower conjoining member 458. This may be advantageous, for example, to accommodate a larger sized spring.

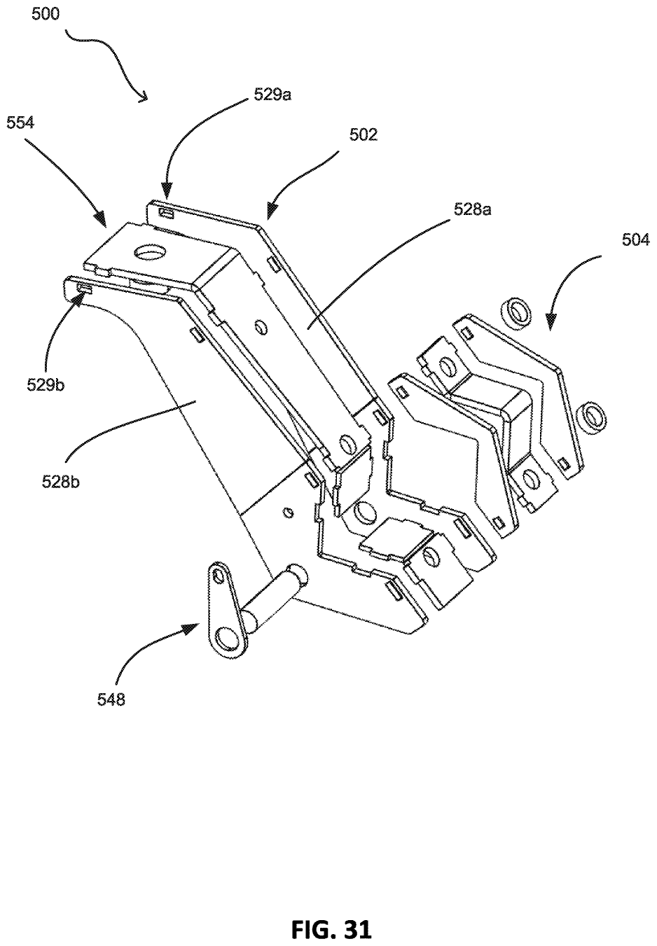

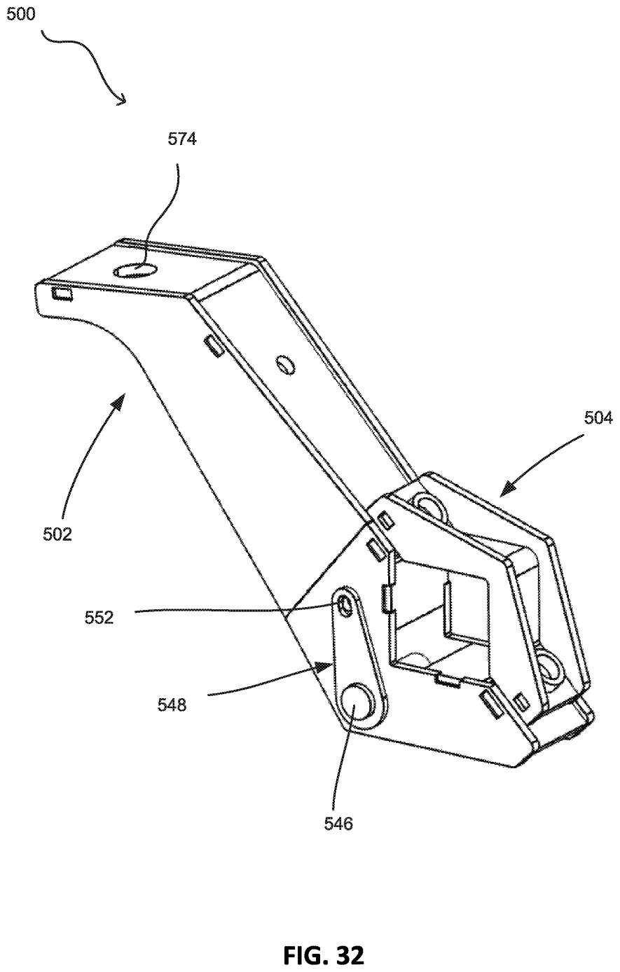

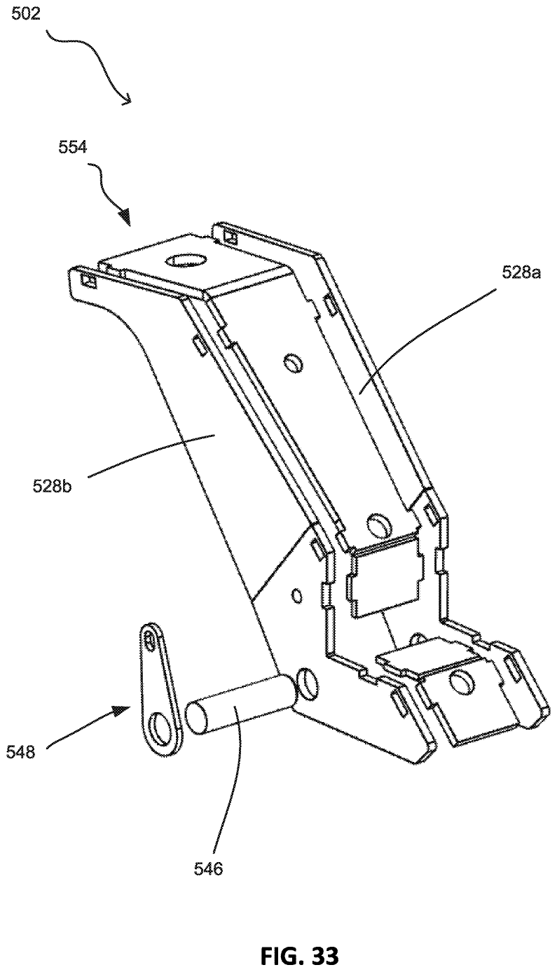

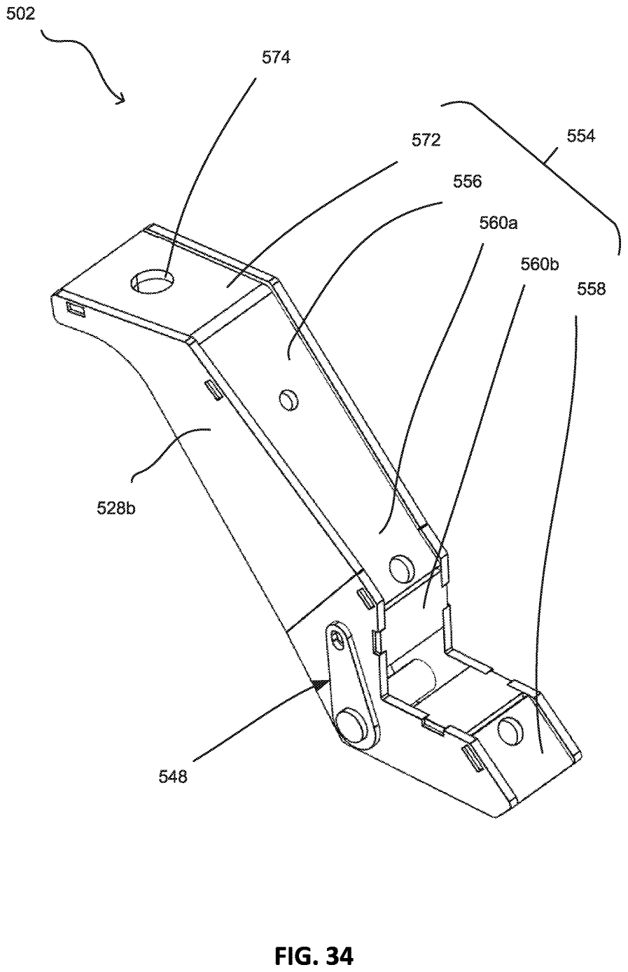

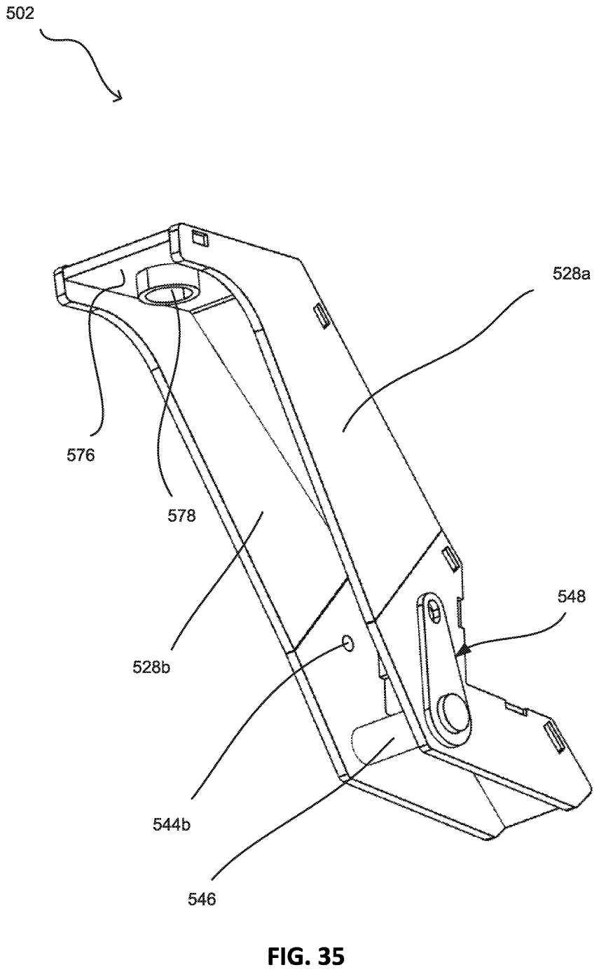

Referring now to FIGS. 31-35, a second implementation of a vertical spring orientation frame engaging assembly 500 and tower 502 is shown, according to examples. Frame engaging assembly 500 shares many similarities with the previously discussed vertical frame engaging assembly 400, and similar elements will be iterated by 100.

Frame engaging assembly 500 may differ from frame engaging assembly 400, for example, by having a different height, width, installment angle, part thickness, or any other variation to accommodate various plow models, spring sizes, frame cross sections, or strength requirements, for example.

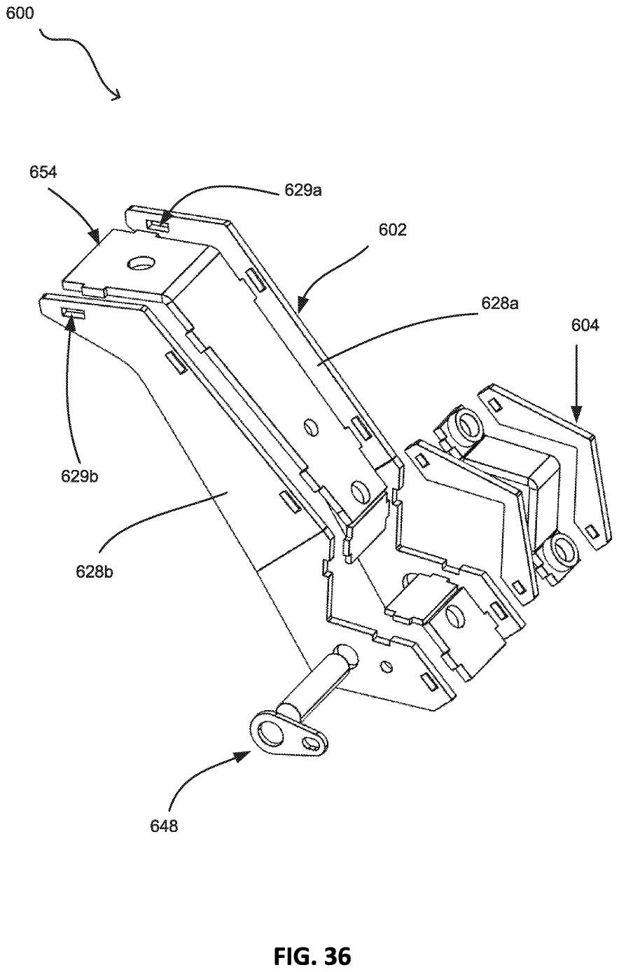

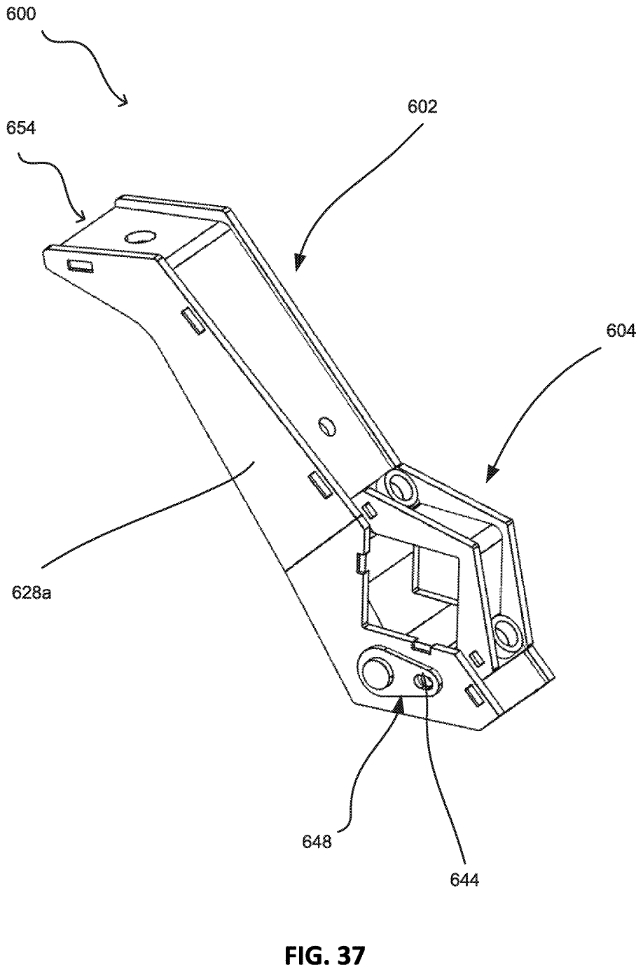

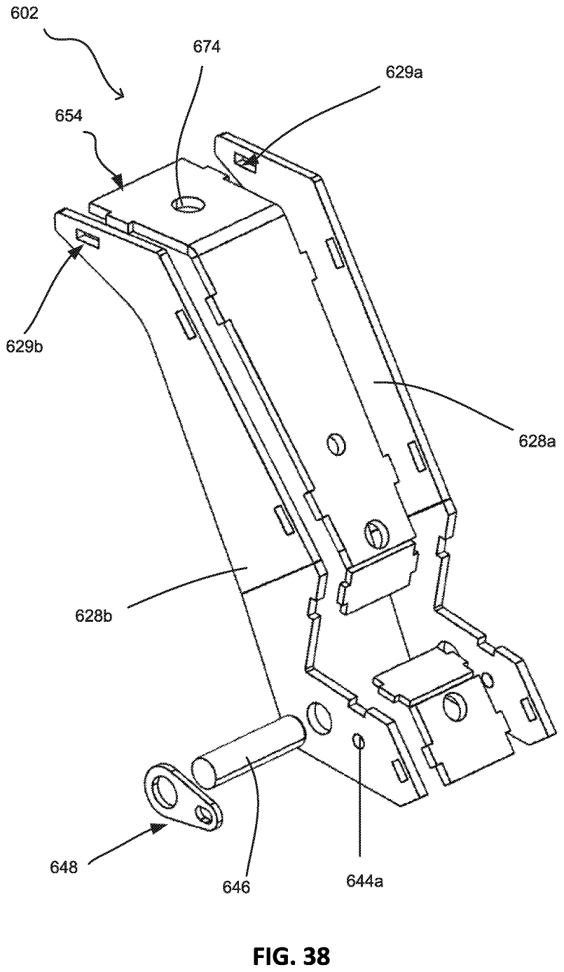

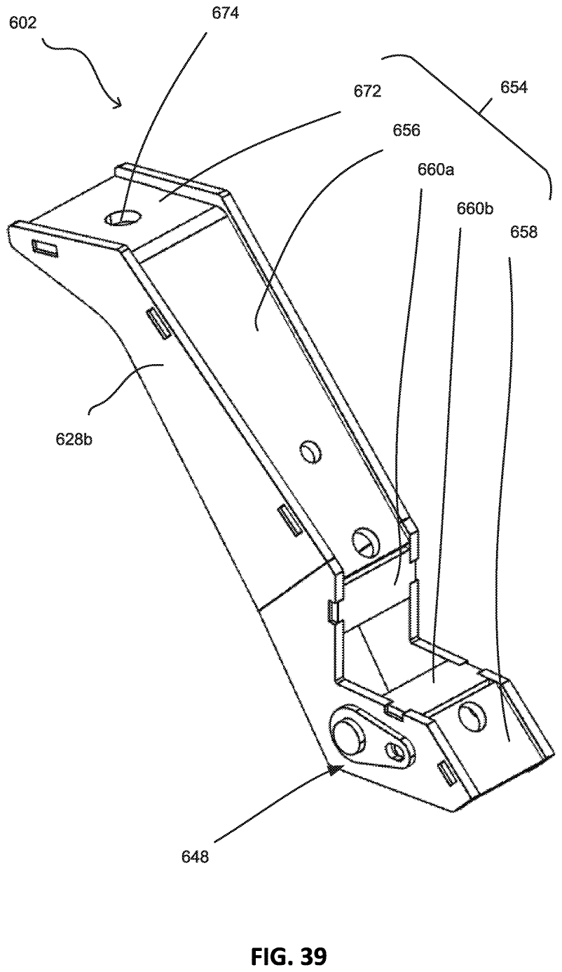

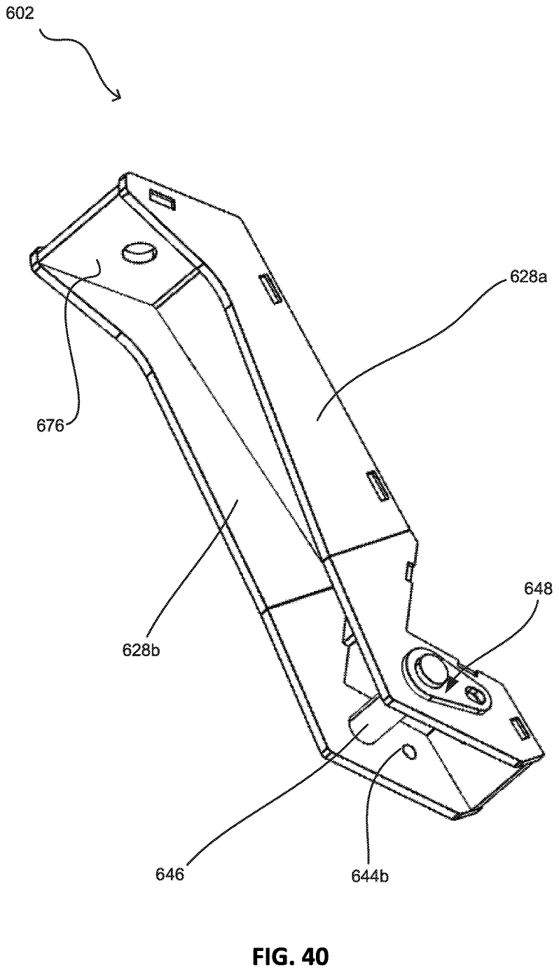

Referring now to FIGS. 36-40, a third implementation of a vertical spring orientation frame engaging assembly 600 and tower 602 is shown, according to examples. Frame engaging assembly 600 shares many similarities with the previously discussed vertical frame engaging assemblies. Frame engaging assembly 600 may differ, for example by having a different height, width, installment angle, part thickness, or any other variation to accommodate various plow models, spring sizes, frame cross sections, or strength requirements, for example.

As another noticeable difference, the pivot pin locking bracket 648 is configured to be installed in a different orientation along one of the tower sidewalls 628a/b, due to the location of the pivot pin locking feature 644. As shown, the pivot pin locking bracket 648 is configured to be installed substantially horizontal.

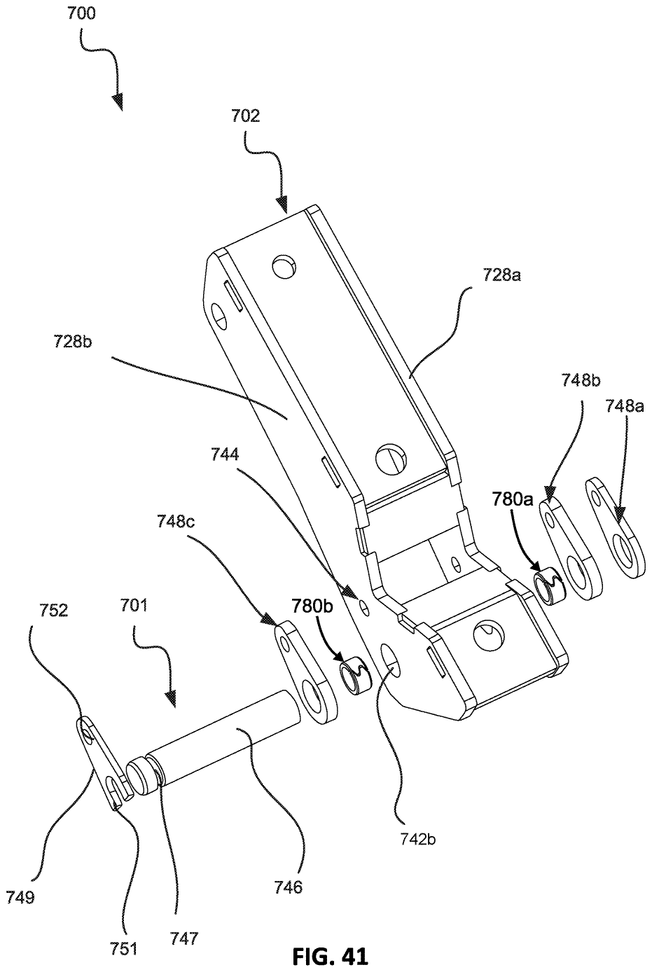

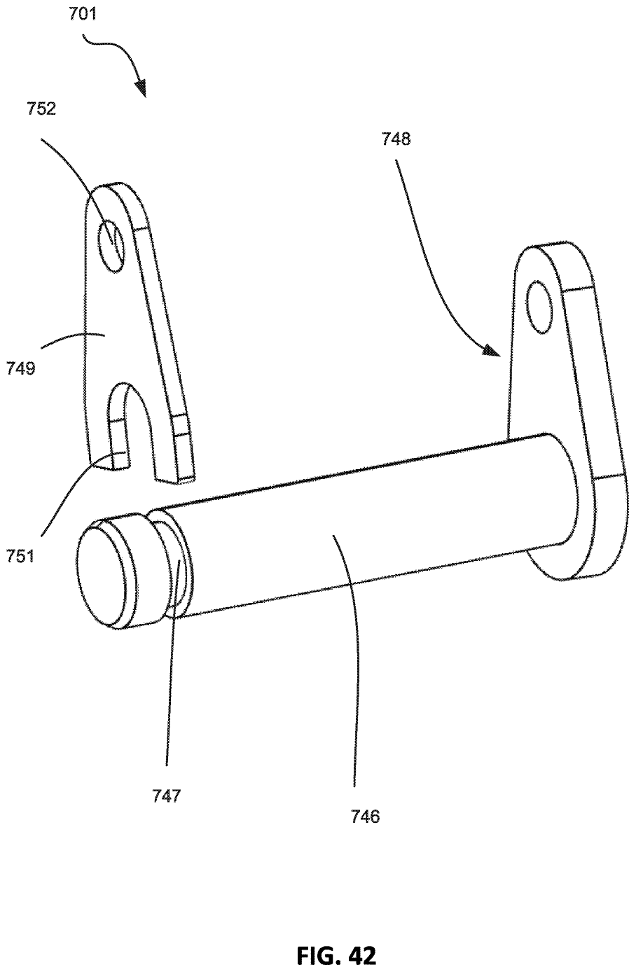

Referring now to FIGS. 41-42, another example frame engaging assembly 700 is shown, according to an exemplary implementation. The frame engaging assembly 700 shares many similarities with previously described frame engaging assemblies, and differs mainly by using a different pivot pin arrangement 701. The tower 702, for example, corresponds to previously discussed tower 202. It is to be appreciated, however, that the subsequently discussed pivot pin arrangement 701 can be used with any tower or frame engagement assembly previously discussed, whether it is a horizontal or vertical spring configuration.

The pivot pin arrangement 701 comprises a pivot pin 746 that shares many similarities to previously discussed pivot pins, and similar features will be numbered similarly. Pivot pin 746 mainly differs by the addition of a groove 747 around the perimeter of the pivot pin 746. When the pivot pin 746 is secured within the tower 702 with a pivot pin locking bracket 748 on one of the tower sidewalls 728a/b (as previously described), the groove 747 protrudes past the opposing tower sidewall 728a/b. A u-clip 749 can comprise a pin securing feature 752 configured to align with pivot pin locking feature 744 to secure the u-clip 749 to the tower sidewall 728a/b, as previously discussed with regard to pivot pin locking bracket 748. Further, the u-clip 749 defines a u-shaped portion 751 configured to receive the pivot pin groove 747.

In this way, when the u-clip 749 receives the groove 747 and is secured to the tower sidewall 728a/b, the resulting structure is strengthened in several regards. For example, the u-clip and pivot pin locking bracket 748 provide a rigid support structure outside of both tower sidewalls 728a/b. This can provide reinforcement along a longitudinal axis defined by the pivot pin 746 and prevent the tower sidewalls 728a/b from straining and expanding along this axis, which may increase longevity of the structure. Further, the u-clip 749 can provide further radial support to the tower sidewall 728a/b and prevent the pin 746 from wearing into the tower sidewall 728a/b, which may enlarge the pivot pin receiving holes 724a/b. To this effect, additional pin locking brackets 748a/b/c may be added in any amounts to further reinforce the pin receiving holes 724a/b. Additional pin locking brackets 748a/b/c may also be used in other examples, such as those with a pivot pin 746 without a groove.

It is to be appreciated that this example of a pivot pin 746, while shown in use with an exemplary tower 702, could be used with any frame engagement assembly and tower configuration previously discussed.

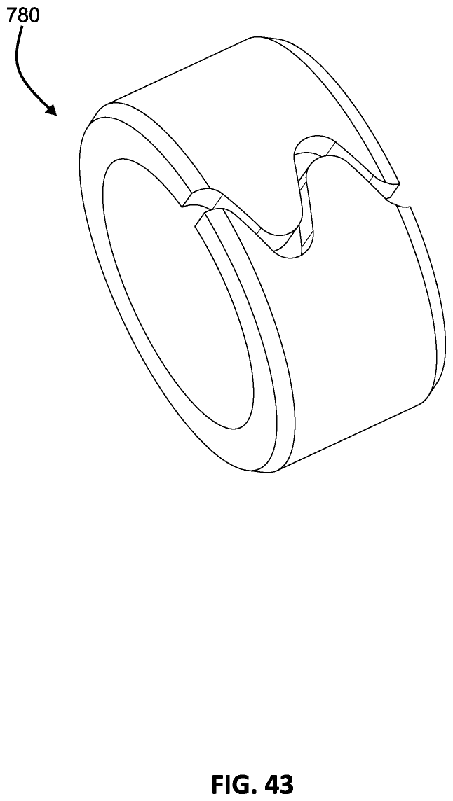

Further, as shown in FIG. 41 and in more detail in FIG. 43, in some examples at least one bushing 780a and 780b may be used. The at least one bushing 780a/b seats within the pivot pin receiving hole 742a/b defined by the tower sidewalls 728a/b. The pivot pin 746 is then received within both the at least one bushing 780a/b and pin receiving holes 742a/b. In an exemplary implementation, the pin locking brackets 748b/c are affixed to the tower sidewalls 728a/b, by fasteners or welding, for example. In these examples, the width of the at least one bushing 780a/b may be equal to or greater than the combined width of the tower sidewall 728a/b and its respective pin locking bracket 748b/c. Accordingly, the at least one bushing 780a/b is retained within both the tower sidewall 728a/b and the respective pin locking bracket 748b/c. In other examples, the at least one bushing 780 comprises a single elongated bushing that extends between, and is received within, both pin receiving holes 742a/b. As an exemplary advantage, use of at least one bushing 780a/b may prolong the life of the frame engaging assembly 700 by eliminating direct contact between the pivot pin 746 and tower sidewalls 728a/b which might otherwise deform or wear away the sidewalls 728a/b. Similarly, if the at least one bushing 780a/b is worn or damaged, it may be replaced easier and more cheaply than replacing the entire frame engaging assembly 700. The at least one bushing 780a/b may be for example, a commonly sized off-the-shelf component. Further, using at least one bushing 780a/b may increase the surface area in contact with the pivot pin 746, thereby reducing stress on the pivot pin 746 and extending its operational life.

As shown in FIG. 43, in an exemplary implementation, the at least one bushing 780a/b comprises at least one spring bushing. The spring bushing may have a relaxed state with a diameter greater than the diameter of the pivot pin receiving hole 742a/b. The spring bushing may then be forced into a compressed diameter that is smaller than the pivot pin receiving hole 742a/b such that the spring bushing may be inserted into the pivot pin receiving hole 742a/b. In this way, the spring bushing is retained within the pivot pin receiving hole 742a/b at least partially by a biasing force caused by the spring bushing moving towards its relaxed state. It is to be appreciated that at least one bushing 780a/b may be used with any of the previously described frame engaging assemblies and pivot pin configurations.

What is claimed is:

1. A tower for mounting a work implement to agricultural equipment, the tower comprising:
a first sidewall and a second sidewall, the first sidewall defining a first pivot pin hole and the second sidewall defining a second pivot pin hole, wherein the first and second sidewalls further define a plurality of cutouts or protrusions; and
a conjoining plate arrangement disposed between the first and second sidewalls, the conjoining plate arrangement defining the other of the plurality of cutouts or protrusions wherein the cutouts are configured to receive the protrusions.

2. The tower of claim 1, wherein the first and second sidewalls define cutouts, the cutouts further comprising a combination of fully enclosed holes and open-ended slots, and wherein the conjoining plate arrangement defines protrusions.

3. The tower of claim 1, wherein the conjoining plate arrangement comprises an upper conjoining plate member, a lower conjoining plate member, and a first and second frame engaging conjoining plate member.

4. The tower of claim 3, wherein the upper conjoining plate member further comprises a substantially horizontal conjoining plate member.

5. The tower of claim 1, wherein the plurality of cutouts or protrusions are disposed near or along a front edge of the first and second sidewalls.

6. The tower of claim 1, further comprising
a pivot pin configured to be retained within the first and second pivot pin holes, the pivot pin configured to retain a work implement; and
a pivot pin locking bracket configured to non-rotatably retain the pin in the first and second pivot pin holes, the pivot pin configured to be fastened to one or both of the first and second tower sidewalls.

7. The tower of claim 6, wherein the pivot pin comprises a groove, the groove being configured to extend outside of the first and second pivot pin holes, wherein a clip is configured to receive the groove and provide support along an axis defined by the pivot pin.

8. The tower of claim 1, wherein the first and second sidewalls are identical to one another.

9. A frame engagement assembly for mounting a ground engaging work implement to a frame, the frame engagement assembly comprising:
a tower, the tower comprising:
a first tower sidewall;
a second tower sidewall, wherein the first and second tower sidewalls comprise at least one of a cutout or protrusion; and
a tower conjoining plate arrangement positioned between the first and second tower sidewalls, the tower conjoining plate arrangement comprising the other of the at least one cutout or protrusion, wherein the at least one cutout is configured to receive the at least one protrusion; and
a strap, wherein the strap is configured to be secured to the tower conjoining plate arrangement.

10. The frame engagement assembly of claim 9, wherein the strap comprises a U-bolt.

11. The frame engagement assembly of claim 9, wherein the strap comprises:
a first strap sidewall;
a second strap sidewall, wherein each of the first and second strap sidewalls define at least one of a cutout or protrusion; and
a strap conjoining member positioned between the first and second strap sidewalls, the strap conjoining member having at least one of the other of the cutout or protrusion, wherein the at least one cutout is configured to receive the at least one protrusion to connect the strap conjoining member to the first and second strap sidewalls.

12. The frame engagement assembly of claim 11, wherein the first and second strap sidewalls define cutouts and the strap conjoining member defines protrusions.

13. The frame engagement assembly of claim 9, wherein the first and second tower sidewalls further comprise a pivot pin hole configured to receive a pivot pin.

14. The frame engagement assembly of claim 9, wherein the tower conjoining plate arrangement comprises at least an upper conjoining plate member and a lower conjoining plate member.

15. The frame engagement assembly of claim 14, wherein the upper conjoining plate member further comprises a substantially horizontal conjoining plate member.

16. The frame engagement assembly of claim 14, wherein the upper conjoining plate member is wider than the lower conjoining plate member.

17. A mounting assembly for mounting a ground engaging work implement to a plow frame, the mounting assembly comprising:
a first and second mounting arm, the first and second mounting arms having a first end configured to be attached to a ground engaging work implement;
a spring bracket attached to the first and second mounting arms on a second end of the first and second mounting arms, the spring bracket configured to retain a spring;
a tower configured to be attached to the ground engaging work implement at a bottom end of the tower, the tower configured to be attached to the spring at a top end of the tower, wherein the tower comprises:
a first and second tower sidewall; and
a conjoining plate arrangement, wherein the conjoining plate arrangement is at least partially welded to the first and second tower sidewall.

18. The mounting assembly of claim 17, wherein the tower is attached to the ground engaging work implement by a non-rotatable pivot pin.

19. The mounting assembly of claim 17, wherein the spring bracket comprises at least two interlocking components.

20. The mounting assembly of claim 17, further comprising a strap, wherein the strap is configured to be secured to the tower around a frame.
